(19) United States
(12) Patent Application Publication
(10) Pub. No.: US 2025/0254308 A1
(43) Pub. Date: Aug. 7, 2025

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Meng WANG, Beijing (CN); Semih ESENLIK, Los Angeles, CA (US); Yaojun WU, Los Angeles, CA (US); Zhaobin ZHANG, Los Angeles, CA (US); Kai ZHANG, Los Angeles, CA (US); Li ZHANG, Los Angeles, CA (US)

(21) Appl. No.: 19/184,957

(22) Filed: Apr. 21, 2025

Related U.S. Application Data
(63) Continuation of application No. PCT/CN2023/125785, filed on Oct. 20, 2023.

(30) Foreign Application Priority Data
Oct. 21, 2022 (WO) PCT/CN2022/126670

(51) Int. Cl. H04N 19/124; H04N 19/119; H04N 19/174; H04N 19/186; H04N 19/189; H04N 19/63

(52) U.S. Cl. CPC H04N 19/124; H04N 19/119; H04N 19/174; H04N 19/186; H04N 19/189; H04N 19/63

(57) ABSTRACT

Embodiments of the disclosure provide a solution for video processing. A method for video processing is proposed. The method includes: determining, for a conversion between a video unit of a video and a bitstream of the video unit, a quantization approach of a latent sample based on whether the latent sample and a neighbor quantized latent sample is in a same region; obtaining, using a neural network, a quantized latent sample comprising a quantized luma latent sample and a quantized chroma latent sample by applying the quantization approach to the latent sample; and performing the conversion based on the quantized latent sample and one of: a synthesis transform network or an analysis transform network.

### CROSS REFERENCE

This application is a continuation of International Application No. PCT/CN2023/125785, filed on Oct. 20, 2023, which claims the benefit of International Application No. PCT/CN2022/126670, filed on Oct. 21, 2022. The entire contents of these applications are hereby incorporated by reference in their entireties.

### FIELDS

Embodiments of the present disclosure relates generally to video processing techniques, and more particularly, to a neural network based image and video compression method with luma and chroma separated tile partitioning.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a quantization approach of a latent sample based on whether the latent sample and a neighbor quantized latent sample ŷ[i+m,j+n] is in a same region; obtaining, using a neural network, a quantized latent sample ŷ[i,j] comprising a quantized luma latent sample (ŷₜ) and a quantized chroma latent sample (ŷ_{c}) by applying the quantization approach to the latent sample; and performing the conversion based on the quantized latent sample and one of: a synthesis transform network or an analysis transform network. In this way, it can improve efficiency of obtaining and signaling quantized luma and chroma latent samples.

In a second aspect, an apparatus for video processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for video processing. The method comprises: determining a quantization approach of a latent sample of a video unit based on whether the latent sample and a neighbor quantized latent sample is in a same region; obtaining, using a neural network, a quantized latent sample comprising a quantized luma latent sample and a quantized chroma latent sample by applying the quantization approach to the latent sample; and generating the bitstream based on the quantized latent sample.

In a fifth aspect, a method for storing a bitstream of a video is proposed. The method comprises: determining a quantization approach of a latent sample of a video unit based on whether the latent sample and a neighbor quantized latent sample is in a same region; obtaining, using a neural network, a quantized latent sample comprising a quantized luma latent sample and a quantized chroma latent sample by applying the quantization approach to the latent sample; generating the bitstream based on the quantized latent sample; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 is a schematic diagram illustrating an example transform coding scheme;

FIG. 5 illustrates example latent representations of an image;

FIG. 6 is a schematic diagram illustrating an example autoencoder implementing a hyperprior model;

FIG. 7 is a schematic diagram illustrating an example combined model configured to jointly optimize a context model along with a hyperprior and the autoencoder;

FIG. 8 illustrates an example encoding process;

FIG. 9 illustrates an example decoding process;

FIG. 10 illustrates an example encoder and decoder with wavelet-based transform;

FIG. 11 illustrates an example output of a forward wavelet-based transform;

FIG. 12 illustrates an example partitioning of the output of a forward wavelet-based transform;

FIG. 13 illustrates an example kernel of a context model, also known as an autoregressive network;

FIG. 14 illustrates other example kernels of an autoregressive network;

FIG. 15 illustrates an example latent representation with multiple regions with different statistical properties;

FIG. 16 illustrates an example tile map according to the disclosure (left) and corresponding wavelet-based transform output (right);

FIG. 17 illustrates an example region map;

FIG. 18 illustrates another example region map;

FIG. 19 illustrates an example utilization of reference information;

FIG. 20 illustrates a flowchart of a method for video processing in accordance with embodiments of the present disclosure; and

FIG. 21 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

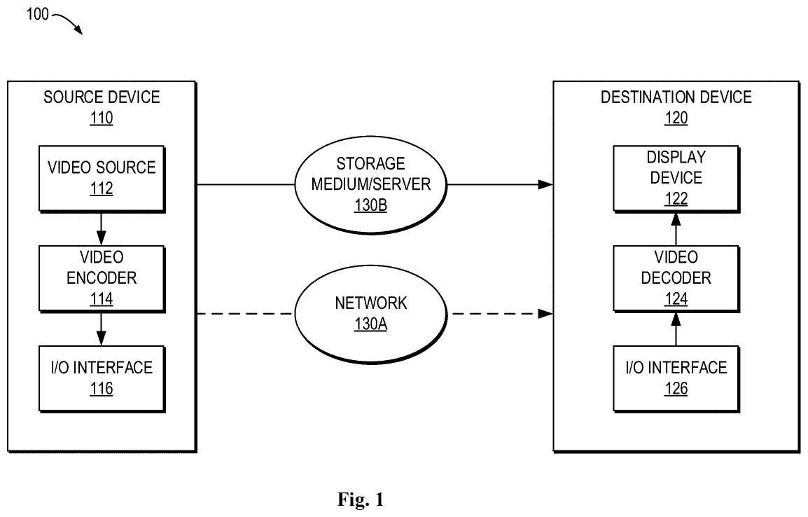

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

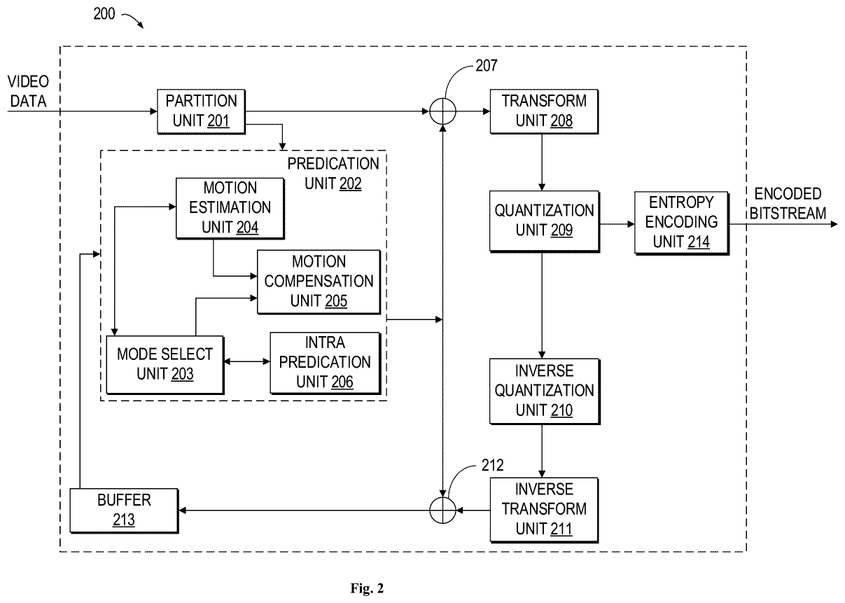

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

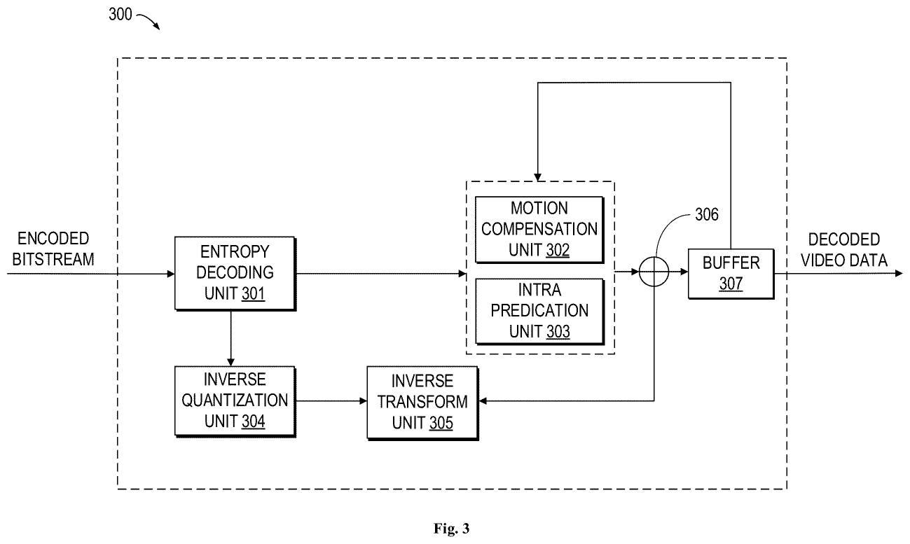

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Initial Discussion

This disclosure is related to a neural network-based image and video compression approach where an autoregressive neural network is utilized. The examples target the problem of sample regions with different statistical properties, especially in terms of the luma and chroma samples, therefore increasing the efficiency of the prediction and compression in the latent domain. The examples additionally improve the speed of prediction by allowing parallel processing and improve the compression performance by allowing the separated partitioning for luma and chroma components.

### 2. Further Discussion

Deep learning is developing in a variety of areas, such as in computer vision and image processing. Inspired by the successful application of deep learning technology to computer vision areas, neural image/video compression technologies are being studied for application to image/video compression techniques. The neural network is designed based on interdisciplinary research of neuroscience and mathematics. The neural network has shown strong capabilities in the context of non-linear transform and classification. An example neural network-based image compression algorithm achieves comparable R-D performance with Versatile Video Coding (VVC), which is a video coding standard developed by the Joint Video Experts Team (JVET) with experts from motion picture experts group (MPEG) and Video coding experts group (VCEG). Neural network-based video compression is an actively developing research area resulting in continuous improvement of the performance of neural image compression. However, neural network-based video coding is still a largely undeveloped discipline due to the inherent difficulty of the problems addressed by neural networks.

### 2.1 Image/Video Compression

Image/video compression usually refers to a computing technology that compresses video images into binary code to facilitate storage and transmission. The binary codes may or may not support losslessly reconstructing the original image/video. Coding without data loss is known as lossless compression and coding while allowing for targeted loss of data in known as lossy compression, respectively. Most coding systems employ lossy compression since lossless reconstruction is not necessary in most scenarios. Usually the performance of image/video compression algorithms is evaluated based on a resulting compression ratio and reconstruction quality. Compression ratio is directly related to the number of binary codes resulting from compression, with fewer binary codes resulting in better compression. Reconstruction quality is measured by comparing the reconstructed image/video with the original image/video, with greater similarity resulting in better reconstruction quality.

Image/video compression techniques can be divided into video coding methods and neural-network-based video compression methods. Video coding schemes adopt transform-based solutions, in which statistical dependency in latent variables, such as discrete cosine transform (DCT) and wavelet coefficients, is employed to carefully hand-engineer entropy codes to model the dependencies in the quantized regime. Neural network-based video compression can be grouped into neural network-based coding tools and end-to-end neural network-based video compression. The former is embedded into existing video codecs as coding tools and only serves as part of the framework, while the latter is a separate framework developed based on neural networks without depending on video codecs.

A series of video coding standards have been developed to accommodate the increasing demands of visual content transmission. The international organization for standardization (ISO)/International Electrotechnical Commission (IEC) has two expert groups, namely Joint Photographic Experts Group (JPEG) and Moving Picture Experts Group (MPEG). International Telecommunication Union (ITU) telecommunication standardization sector (ITU-T) also has a Video Coding Experts Group (VCEG), which is for standardization of image/video coding technology. The influential video coding standards published by these organizations include Joint Photographic Experts Group (JPEG), JPEG 2000, H.262, H.264/advanced video coding (AVC) and H.265/High Efficiency Video Coding (HEVC). The Joint Video Experts Team (JVET), formed by MPEG and VCEG, developed the Versatile Video Coding (VVC) standard. An average of 50% bitrate reduction is reported by VVC under the same visual quality compared with HEVC.

Neural network-based image/video compression/coding is also under development. Example neural network coding network architectures are relatively shallow, and the performance of such networks is not satisfactory. Neural network-based methods benefit from the abundance of data and the support of powerful computing resources, and are therefore better exploited in a variety of applications. Neural network-based image/video compression has shown promising improvements and is confirmed to be feasible. Nevertheless, this technology is far from mature and a lot of challenges should be addressed.

### 2.2 Neural Networks

Neural networks, also known as artificial neural networks (ANN), are computational models used in machine learning technology. Neural networks are usually composed of multiple processing layers, and each layer is composed of multiple simple but non-linear basic computational units. One benefit of such deep networks is a capacity for processing data with multiple levels of abstraction and converting data into different kinds of representations. Representations created by neural networks are not manually designed. Instead, the deep network including the processing layers is learned from massive data using a general machine learning procedure. Deep learning eliminates the necessity of handcrafted representations. Thus, deep learning is regarded useful especially for processing natively unstructured data, such as acoustic and visual signals. The processing of such data has been a longstanding difficulty in the artificial intelligence field.

### 2.3 Neural Networks for Image Compression

Neural networks for image compression can be classified in two categories, including pixel probability models and auto-encoder models. Pixel probability models employ a predictive coding strategy. Auto-encoder models employ a transform-based solution. Sometimes, these two methods are combined together.

### 2.3.1 Pixel Probability Modeling

According to Shannon's information theory, the optimal method for lossless coding can reach the minimal coding rate, which is denoted as −log₂ p(x) where p(x) is the probability of symbol x. Arithmetic coding is a lossless coding method that is believed to be among the optimal methods. Given a probability distribution p(x), arithmetic coding causes the coding rate to be as close as possible to a theoretical limit −log₂ p(x) without considering the rounding error. Therefore, the remaining problem is to determine the probability, which is very challenging for natural image/video due to the curse of dimensionality. The curse of dimensionality refers to the problem that increasing dimensions causes data sets to become sparse, and hence rapidly increasing amounts of data is needed to effectively analyze and organize data as the number of dimensions increases.

Following the predictive coding strategy, one way to model p(x) is to predict pixel probabilities one by one in a raster scan order based on previous observations, where x is an image, can be expressed as follows:

$$p ( x ) = p ( {x}_{1} ) p ( {x}_{2} \vert {x}_{1} ) … p ( {x}_{i} \vert {x}_{1} , , {x}_{i - 1} ) … p ( {x}_{m \times n} \vert {x}_{1} , … , {x}_{m \times n - 1} ) \qquad ( 1 )$$

where m and n are the height and width of the image, respectively. The previous observation is also known as the context of the current pixel. When the image is large, estimation of the conditional probability can be difficult. Thereby, a simplified method is to limit the range of the context of the current pixel as follows:

$$p ( x ) = p ( {x}_{1} ) p ( {x}_{2} \vert {x}_{1} ) … p ( {x}_{i} \vert {x}_{i - k} , , {x}_{i - 1} ) … p ( {x}_{m \times n} \vert {x}_{m \times n - k} , … , {x}_{m \times n - 1} ) \qquad ( 2 )$$

where k is a pre-defined constant controlling the range of the context.

It should be noted that the condition may also take the sample values of other color components into consideration. For example, when coding the red (R), green (G), and blue (B) (RGB) color component, the R sample is dependent on previously coded pixels (including R, G, and/or B samples), the current G sample may be coded according to previously coded pixels and the current R sample. Further, when coding the current B sample, the previously coded pixels and the current R and G samples may also be taken into consideration.

Neural networks may be designed for computer vision tasks, and may also be effective in regression and classification problems. Therefore, neural networks may be used to estimate the probability of p(xᵢ) given a context x₁, x₂, . . . , xᵢ₋₁. In an example neural network design, the pixel probability is employed for binary images according to xᵢ∈{−1, +1}. The neural autoregressive distribution estimator (NADE) is designed for pixel probability modeling. NADE is a feed-forward network with a single hidden layer. In another example, the feed-forward network may include connections skipping the hidden layer. Further, the parameters may also be shared. Example designs perform experiments on the binarized MNIST dataset. In an example, NADE is extended to a real-valued NADE (RNADE) model, where the probability p(xᵢ|x₁, . . . , xᵢ₋₁) is derived with a mixture of Gaussians. The RNADE model feed-forward network also has a single hidden layer, but the hidden layer employs rescaling to avoid saturation and uses a rectified linear unit (ReLU) instead of sigmoid. In another example, NADE and RNADE are improved by using reorganizing the order of the pixels and with deeper neural networks.

Designing advanced neural networks plays an important role in improving pixel probability modeling. In an example neural network, a multi-dimensional long short-term memory (LSTM) is used. The LSTM works together with mixtures of conditional Gaussian scale mixtures for probability modeling. LSTM is a special kind of recurrent neural networks (RNNs) and may be employed to model sequential data. The spatial variant of LSTM may also be used for images later. Several different neural networks may be employed, including recurrent neural networks (RNNs) and convolutional neural networks (CNNs), such as Pixel RNN (PixelRNN) and Pixel CNN (PixelCNN), respectively. In PixelRNN, two variants of LSTM, denoted as row LSTM and diagonal bidirectional LSTM (BiLSTM) are employed. Diagonal BiLSTM is specifically designed for images. PixelRNN incorporates residual connections to help train deep neural networks with up to twelve layers. In PixelCNN, masked convolutions are used to adjust for the shape of the context. PixelRNN and PixelCNN are more dedicated to natural images. For example, PixelRNN and PixelCNN consider pixels as discrete values (e.g., 0, 1, . . . , 255) and predict a multinomial distribution over the discrete values. Further, PixelRNN and PixelCNN deal with color images in RGB color space. In addition, PixelRNN and PixelCNN work well on the large-scale image dataset image network (ImageNet). In an example, a Gated PixelCNN is used to improve the PixelCNN. Gated PixelCNN achieves comparable performance with PixelRNN, but with much less complexity. In an example, a PixelCNN++ is employed with the following improvements upon PixelCNN: a discretized logistic mixture likelihood is used rather than a 256-way multinomial distribution; down-sampling is used to capture structures at multiple resolutions; additional short-cut connections are introduced to speed up training; dropout is adopted for regularization; and RGB is combined for one pixel. In another example, PixelSNAIL combines casual convolutions with self-attention.

Most of the above methods directly model the probability distribution in the pixel domain. Some designs also model the probability distribution as conditional based upon explicit or latent representations. Such a model can be expressed as:

$$p ( x \vert h ) = {\prod }_{i = 1}^{m \times n} p ( {x}_{i} \vert {x}_{1} , … , {x}_{i - 1} , h ) \qquad ( 3 )$$

where h is the additional condition and p(x)=p(h)p(x|h) indicates the modeling is split into an unconditional model and a conditional model. The additional condition can be image label information or high-level representations.

### 2.3.2 Auto-Encoder

An Auto-encoder is now described. The auto-encoder is trained for dimensionality reduction and include an encoding component and a decoding component. The encoding component converts the high-dimension input signal to low-dimension representations. The low-dimension representations may have reduced spatial size, but a greater number of channels. The decoding component recovers the high-dimension input from the low-dimension representation. The auto-encoder enables automated learning of representations and eliminates the need of hand-crafted features, which is also believed to be one of the most important advantages of neural networks.

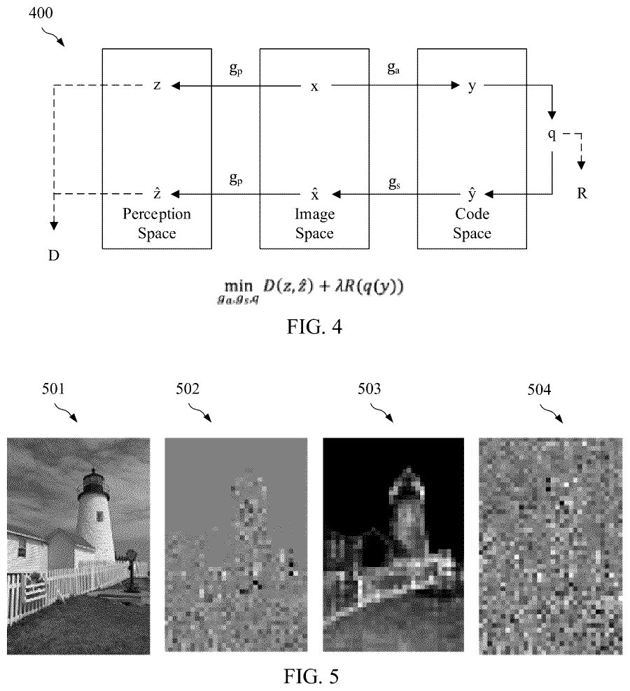

FIG. 4 is a schematic diagram illustrating an example transform coding scheme 400. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

An auto-encoder network can be applied to lossy image compression. The learned latent representation can be encoded from the well-trained neural networks. However, adapting the auto-encoder to image compression is not trivial since the original auto-encoder is not optimized for compression, and is thereby not efficient for direct use as a trained auto-encoder. In addition, other major challenges exist. First, the low-dimension representation should be quantized before being encoded. However, the quantization is not differentiable, which is required in backpropagation while training the neural networks. Second, the objective under a compression scenario is different since both the distortion and the rate need to be take into consideration. Estimating the rate is challenging. Third, a practical image coding scheme should support variable rate, scalability, encoding/decoding speed, and interoperability. In response to these challenges, various schemes are under development.

An example auto-encoder for image compression using the example transform coding scheme 400 can be regarded as a transform coding strategy. The original image x is transformed with the analysis network y=gₐ(x), where y is the latent representation to be quantized and coded. The synthesis network inversely transforms the quantized latent representation ŷ back to obtain the reconstructed image \hat{x}=gₛ(ŷ). The framework is trained with the rate-distortion loss function, [symbol] =D+λR, where D is the distortion between x and \hat{x}, R is the rate calculated or estimated from the quantized representation ŷ, and λ is the Lagrange multiplier. D can be calculated in either pixel domain or perceptual domain. Most example systems follow this prototype and the differences between such systems might only be the network structure or loss function.

In terms of network structure, RNNs and CNNs are the most widely used architectures. In the RNNs relevant category, an example general framework for variable rate image compression uses RNN. The example uses binary quantization to generate codes and does not consider rate during training. The framework provides a scalable coding functionality, where RNN with convolutional and deconvolution layers performs well. Another example offers an improved version by upgrading the encoder with a neural network similar to PixelRNN to compress the binary codes. The performance is better than JPEG on a Kodak image dataset using multi-scale structural similarity (MS-SSIM) evaluation metric. Another example further improves the RNN-based solution by introducing hidden-state priming. In addition, an SSIM-weighted loss function is also designed, and a spatially adaptive bitrates mechanism is included. This example achieves better results than better portable graphics (BPG) on the Kodak image dataset using MS-SSIM as evaluation metric. Another example system supports spatially adaptive bitrates by training stop-code tolerant RNNs.

Another example proposes a general framework for rate-distortion optimized image compression. The example system uses multiary quantization to generate integer codes and considers the rate during training. The loss is the joint rate-distortion cost, which can be mean square error (MSE) or other metrics. The example system adds random uniform noise to stimulate the quantization during training and uses the differential entropy of the noisy codes as a proxy for the rate. The example system uses generalized divisive normalization (GDN) as the network structure, which includes a linear mapping followed by a nonlinear parametric normalization. The effectiveness of GDN on image coding is verified. Another example system includes improved version that uses three convolutional layers each followed by a down-sampling layer and a GDN layer as the forward transform. Accordingly, this example version uses three layers of inverse GDN each followed by an up-sampling layer and convolution layer to stimulate the inverse transform. In addition, an arithmetic coding method is devised to compress the integer codes. The performance is reportedly better than JPEG and JPEG 2000 on Kodak dataset in terms of MSE. Another example improves the method by devising a scale hyper-prior into the auto-encoder. The system transforms the latent representation y with a subnet hₐ to z=hₐ(y) and z is quantized and transmitted as side information. Accordingly, the inverse transform is implemented with a subnet hₛ that decodes from the quantized side information \hat{z} to the standard deviation of the quantized ŷ, which is further used during the arithmetic coding of ŷ. On the Kodak image set, this method is slightly worse than BGP in terms of peak signal to noise ratio (PSNR). Another example system further exploits the structures in the residue space by introducing an autoregressive model to estimate both the standard deviation and the mean. This example uses a Gaussian mixture model to further remove redundancy in the residue. The performance is on par with VVC on the Kodak image set using PSNR as evaluation metric.

### 2.3.3 Hyper Prior Model

FIG. 5 illustrates example latent representations of an image. FIG. 5 includes an image 501 from the Kodak dataset, visualization of the latent 502 representation y of the image 501, a standard deviations σ 503 of the latent 502, and latents y 504 after a hyper prior network is introduced. A hyper prior network includes a hyper encoder and decoder. In the transform coding approach to image compression, as shown in FIG. 4, the encoder subnetwork transforms the image vector x using a parametric analysis transform gₐ(x, Ø_{g}) into a latent representation y, which is then quantized to form ŷ. Because ŷ is discrete-valued, ŷ can be losslessly compressed using entropy coding techniques such as arithmetic coding and transmitted as a sequence of bits.

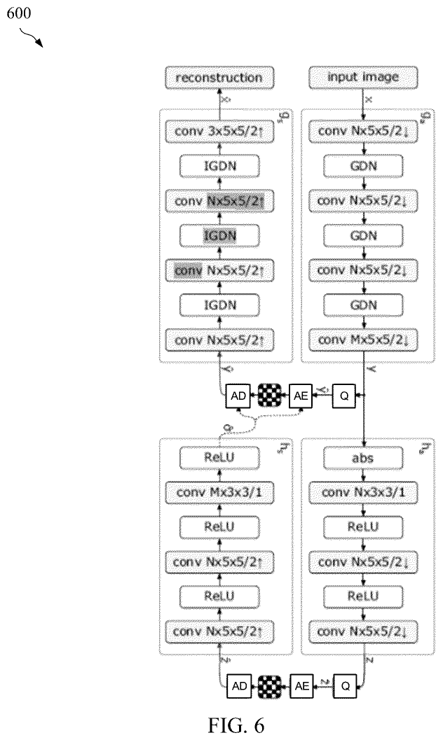

As evident from the latent 502 and the standard deviations σ 503 of FIG. 5, there are significant spatial dependencies among the elements of ŷ. Notably, their scales (standard deviations σ 503) appear to be coupled spatially. An additional set of random variables \hat{z} may be introduced to capture the spatial dependencies and to further reduce the redundancies. In this case the image compression network is depicted in FIG. 6.

FIG. 6 is a schematic diagram 600 illustrating an example network architecture of an autoencoder implementing a hyperprior model. The upper side shows an image autoencoder network, and the lower side corresponds to the hyperprior subnetwork. The analysis and synthesis transforms are denoted as gₐ and gₛ, respectively. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In schematic diagram 600, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers \hat{z} from the compressed signal. The decoder then uses hₛ to obtain σ, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 504 in FIG. 5 correspond to the quantized latent when the hyper encoder/decoder are used. Compared to the standard deviations σ 503, the spatial redundancies are significantly reduced as the samples of the quantized latent are less correlated.

### 2.3.4 Context Model

Although the hyperprior model improves the modelling of the probability distribution of the quantized latent ŷ, additional improvement can be obtained by utilizing an autoregressive model that predicts quantized latents from their causal context, which may be known as a context model.

The term auto-regressive indicates that the output of a process is later used as an input to the process. For example, the context model subnetwork generates one sample of a latent, which is later used as input to obtain the next sample.

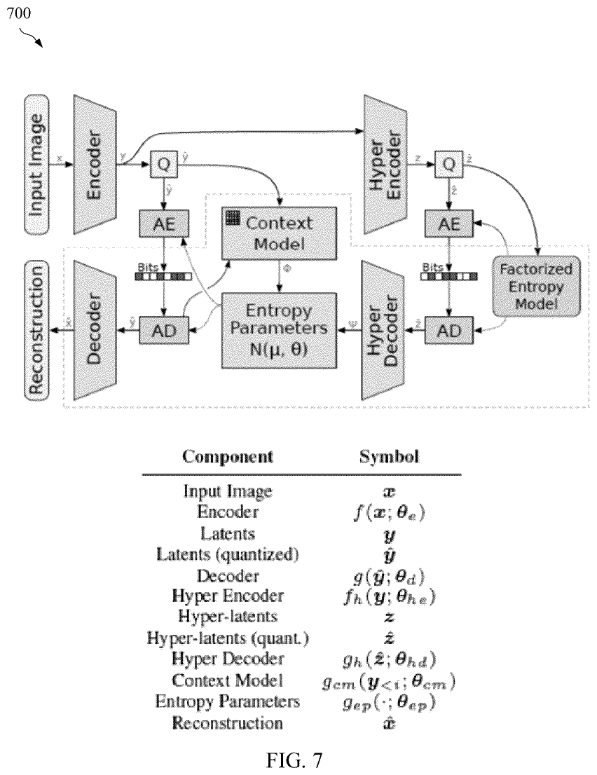

FIG. 7 is a schematic diagram 700 illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

An example system utilizes a joint architecture where both a hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in schematic diagram 700, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to the schematic diagram 700, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 the Encoding Process Using Joint Auto-Regressive Hyper Prior Model

The design in FIG. 4. corresponds an example combined compression method. In this section and the next, the encoding and decoding processes are described separately.

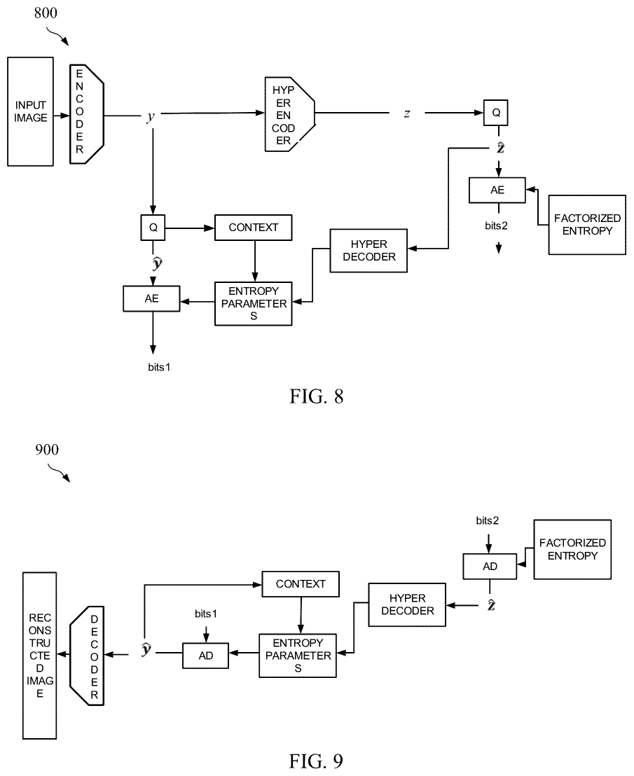

FIG. 8 illustrates an example encoding process 800. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. The latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

where the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, where the samples in a row are processed from left to right. In such a scenario (where the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally, the first and the second bitstream are transmitted to the decoder as result of the encoding process. It is noted that the other names can be used for the modules described above.

In the above description, all of the elements in FIG. 8 are collectively called an encoder. The analysis transform that converts the input image into latent representation is also called an encoder (or auto-encoder).

### 2.3.6 the Decoding Process Using Joint Auto-Regressive Hyper Prior Model

FIG. 9 illustrates an example decoding process 900. FIG. 9 depicts a decoding process separately.

In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change.

After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore, the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder.

After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization. Finally, the fully reconstructed quantized latent ŷ is input to the synthesis transform (denoted as decoder in FIG. 9) module to obtain the reconstructed image.

In the above description, the all of the elements in FIG. 9 are collectively called decoder. The synthesis transform that converts the quantized latent into reconstructed image is also called a decoder (or auto-decoder).

### 2.3.7 Wavelet Based Neural Compression Architecture

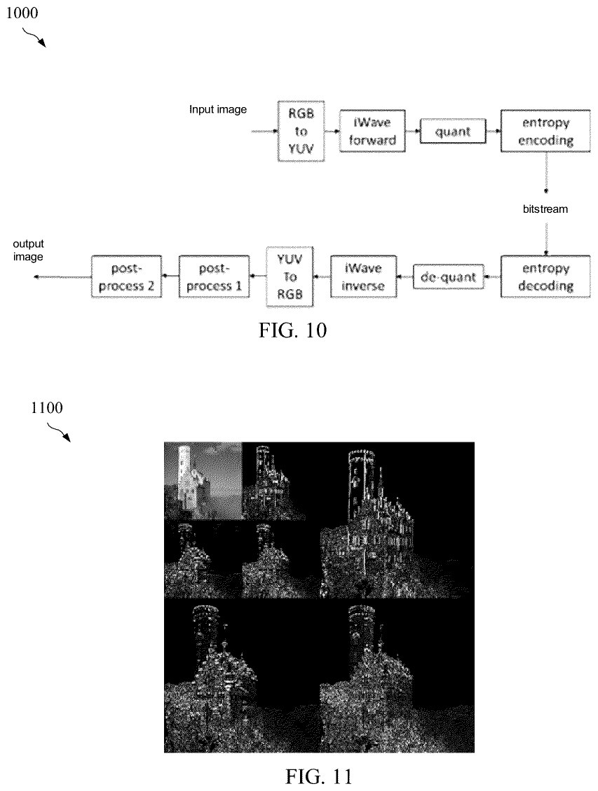

The analysis transform (denoted as encoder) in FIG. 8 and the synthesis transform (denoted as decoder) in FIG. 9 might be replaced by a wavelet based transform. FIG. 10 below shows an example such an implementation. In the figure first the input image is converted from an RGB color format to a YUV color format. This conversion process is optional, and can be missing in other implementations. If however such a conversion is applied at the input image, a back conversion (from YUV to RGB) is also applied before the output image is generated. Moreover there are 2 additional post processing modules (post-process 1 and 2) shown in the figure. These modules are also optional, hence might be missing in other implementations. The core of an encoder with wavelet-based transform is composed of a wavelet-based forward transform, a quantization module and an entropy coding module. After these 3 modules are applied to the input image, the bitstream is generated. The core of the decoding process is composed of entropy decoding, de-quantization process and an inverse wavelet-based transform operation. The decoding process convers the bitstream into output image. The encoding and decoding processes are depicted FIG. 10.

FIG. 10 illustrates an example encoder and decoder 1000 with wavelet-based transform.

After the wavelet-based forward transform is applied to the input image, in the output of the wavelet-based forward transform the image is split into its frequency components. The output of a 2-dimensional forward wavelet transform (depicted as iWave forward module in the figure above) might take the form depicted in FIG. 11. The input of the transform is an image of a castle. In the example, after the transform an output with 7 distinct regions are obtained. The number of distinct regions depend on the specific implementation of the transform and might different from 7. Potential number of regions are 4, 7, 10, 13, . . . .

FIG. 11 illustrates an example output 1100 of a forward wavelet-based transform.

In FIG. 11, the input image is transformed into 7 regions with 3 small images and 4 even smaller images. The transformation is based on the frequency components, the small image at the bottom right quarter comprises the high frequency components in both horizontal and vertical directions. The smallest image at the top-left corner on the other hand comprises the lowest frequency components both in the vertical and horizontal directions. The small image on the top-right quarter comprises the high frequency components in the horizontal direction and low frequency components in the vertical direction.

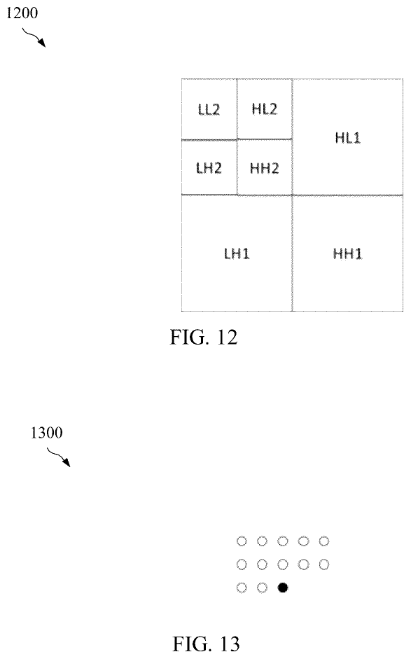

FIG. 12 illustrates an example partitioning 1200 of the output of a forward wavelet-based transform. FIG. 12 depicts a possible splitting of the latent representation after the 2D forward transform. The latent representation are the samples (latent samples, or quantized latent samples) that are obtained after the 2D forward transform. The latent samples are divided into 7 sections above, denoted as HH1, LH1, HL1, LL2, HL2, LH2 and HH2. The HH1 describes that the section comprises high frequency components in the vertical direction, high frequency components in the horizontal direction and that the splitting depth is 1. HL2 describes that the section comprises low frequency components in the vertical direction, high frequency components in the horizontal direction and that the splitting depth is 2.

After the latent samples are obtained at the encoder by the forward wavelet transform, they are transmitted to the decoder by using entropy coding. At the decoder, entropy decoding is applied to obtain the latent samples, which are then inverse transformed (by using iWave inverse module in FIG. 10) to obtain the reconstructed image.

### 2.4 Neural Networks for Video Compression

Similar to video coding technologies, neural image compression serves as the foundation of intra compression in neural network-based video compression. Thus, development of neural network-based video compression technology is behind development of neural network-based image compression because neural network-based video compression technology is of greater complexity and hence needs far more effort to solve the corresponding challenges. Compared with image compression, video compression needs efficient methods to remove inter-picture redundancy. Inter-picture prediction is then a major step in these example systems. Motion estimation and compensation is widely adopted in video codecs, but is not generally implemented by trained neural networks.

Neural network-based video compression can be divided into two categories according to the targeted scenarios: random access and the low-latency. In random access case, the system allows decoding to be started from any point of the sequence, typically divides the entire sequence into multiple individual segments, and allows each segment to be decoded independently. In a low-latency case, the system aims to reduce decoding time, and thereby temporally previous frames can be used as reference frames to decode subsequent frames.

### 2.4.1 Low-Latency

An example system employs a video compression scheme with trained neural networks. The system first splits the video sequence frames into blocks and each block is coded according to an intra coding mode or an inter coding mode. If intra coding is selected, there is an associated auto-encoder to compress the block. If inter coding is selected, motion estimation and compensation are performed and a trained neural network is used for residue compression. The outputs of auto-encoders are directly quantized and coded by the Huffman method.

Another neural network-based video coding scheme employs PixelMotionCNN. The frames are compressed in the temporal order, and each frame is split into blocks which are compressed in the raster scan order. Each frame is first extrapolated with the preceding two reconstructed frames. When a block is to be compressed, the extrapolated frame along with the context of the current block are fed into the PixelMotionCNN to derive a latent representation. Then the residues are compressed by a variable rate image scheme. This scheme performs on par with H.264.

Another example system employs an end-to-end neural network-based video compression framework, in which all the modules are implemented with neural networks. The scheme accepts a current frame and a prior reconstructed frame as inputs. An optical flow is derived with a pre-trained neural network as the motion information. The motion information is warped with the reference frame followed by a neural network generating the motion compensated frame. The residues and the motion information are compressed with two separate neural auto-encoders. The whole framework is trained with a single rate-distortion loss function. The example system achieves better performance than H.264.

Another example system employs an advanced neural network-based video compression scheme. The system inherits and extends video coding schemes with neural networks with the following major features. First the system uses only one auto-encoder to compress motion information and residues. Second, the system uses motion compensation with multiple frames and multiple optical flows. Third, the system uses an on-line state that is learned and propagated through the following frames over time. This scheme achieves better performance in MS-SSIM than HEVC reference software.

Another example system uses an extended end-to-end neural network-based video compression framework. In this example, multiple frames are used as references. The example system is thereby able to provide more accurate prediction of a current frame by using multiple reference frames and associated motion information. In addition, a motion field prediction is deployed to remove motion redundancy along temporal channel. Postprocessing networks are also used to remove reconstruction artifacts from previous processes. The performance of this system is better than H.265 by a noticeable margin in terms of both PSNR and MS-SSIM.

Another example system uses scale-space flow to replace an optical flow by adding a scale parameter based on a framework. This example system may achieve better performance than H.264. Another example system uses a multi-resolution representation for optical flows based. Concretely, the motion estimation network produces multiple optical flows with different resolutions and let the network learn which one to choose under the loss function. The performance is slightly better than H.265.

### 2.4.2 Random ACCESS

Another example system uses a neural network-based video compression scheme with frame interpolation. The key frames are first compressed with a neural image compressor and the remaining frames are compressed in a hierarchical order. The system performs motion compensation in the perceptual domain by deriving the feature maps at multiple spatial scales of the original frame and using motion to warp the feature maps. The results are used for the image compressor. The method is on par with H.264.

An example system uses a method for interpolation-based video compression. The interpolation model combines motion information compression and image synthesis. The same auto-encoder is used for image and residual. Another example system employs a neural network-based video compression method based on variational auto-encoders with a deterministic encoder. Concretely, the model includes an auto-encoder and an auto-regressive prior. Different from previous methods, this system accepts a group of pictures (GOP) as inputs and incorporates a three dimensional (3D) autoregressive prior by taking into account of the temporal correlation while coding the latent representations. This system provides comparative performance as H.265.

### 2.5 Preliminaries

Almost all the natural image and/or video is in digital format. A grayscale digital image can be represented by x∈ [symbol] ^{m×n}, where D is the set of values of a pixel, m is the image height, and n is the image width. For example, [symbol] ={0, 1, 2, . . . , 255} is an example setting, and in this case | [symbol] |=256=2⁸. Thus, the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green, and Blue information. Similar to the 8-bit grayscale image, an uncompressed 8-bit RGB image has 24 bpp. Digital images/videos can be represented in different color spaces. The neural network-based video compression schemes are mostly developed in RGB color space while the video codecs typically use a YUV color space to represent the video sequences. In YUV color space, an image is decomposed into three channels, namely luma (Y), blue difference chroma (Cb) and red difference chroma (Cr). Y is the luminance component and Cb and Cr are the chroma components. The compression benefit to YUV occur because Cb and Cr are typically down sampled to achieve pre-compression since human vision system is less sensitive to chroma components.

A color video sequence is composed of multiple color images, also called frames, to record scenes at different timestamps. For example, in the RGB color space, a color video can be denoted by X={x₀, x₁, . . . , xₜ, . . . , x_{T-1}} where T is the number of frames in a video sequence and x∈ [symbol] ^{m×n}. If m=1080, n=1920, [ [symbol] ]=2⁸, and the video has 50 frames-per-second (fps), then the data rate of this uncompressed video is 1920×1080×8×3×50=2,488,320,000 bits-per-second (bps). This results in about 2.32 gigabits per second (Gbps), which uses a lot storage and should be compressed before transmission over the internet.

Usually the lossless methods can achieve a compression ratio of about 1.5 to 3 for natural images, which is clearly below streaming requirements. Therefore, lossy compression is employed to achieve a better compression ratio, but at the cost of incurred distortion. The distortion can be measured by calculating the average squared difference between the original image and the reconstructed image, for example based on MSE. For a grayscale image, MSE can be calculated with the following equation.

$$MSE = \frac{{\vert x - \hat{x} \vert}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, the compression ratio given the resulting rate, or vice versa, can be compared. However, to compare different lossy compression methods, the comparison has to take into account both the rate and reconstructed quality. For example, this can be accomplished by calculating the relative rates at several different quality levels and then averaging the rates. The average relative rate is known as Bjontegaard's delta-rate (BD-rate). There are other aspects to evaluate image and/or video coding schemes, including encoding/decoding complexity, scalability, robustness, and so on.

### 3. Technical Problems Solved by Disclosed Technical Solutions

Some compression networks include a prediction module (for example an autoregressive neural network) to improve the compression performance. The autoregressive neural network utilizes already processed samples to obtain a next sample, hence the name autoregressive (it predicts future values based on past values). On the other hand, the samples belonging to one part of the latent representation might have very different statistical properties than the other parts. In such a case the performance of the autoregressive model deteriorates. Moreover, in some image compression networks, the luma and chroma channels are jointly processed in terms of the prediction and context modeling, such that the compression performance may degrades.

### 3.2 Details of the Problem

FIG. 13 illustrates an example kernel 1300 of a context model, also known as an autoregressive network. In FIG. 13, an example processing kernel is depicted that can be used to process the latent samples ŷ. The processing kernel is part of the auto-regressive processing module (sometimes called the context module). In the example the context module utilizes 12 samples around the current ŷ[:,i,j], to generate the sample ŷ[:,i,j]. Those samples are depicted in FIG. 12 below with empty circles. The sample ŷ[:,i,j] is depicted with filled circle.

As one can understand from FIG. 13, the processing of sample ŷ[:,i,j] requires that the samples ŷ[:,i−1,j], ŷ[:,i,j−1], ŷ[:,i−1,j−1], ŷ[:,i−2,j], ŷ[:,i−1,j−1], ŷ[:,i,j−2], ŷ[:,i−1,j−2], ŷ[:,i−2,j−2], ŷ[:,i+1,j−1], ŷ[:,i+1,j−1], ŷ[:,i+1,j−2], ŷ[:, i+2,j−2], (i.e. the 12 samples from the top-left two rows/columns) to be available and already constructed. This poses a strict processing order for the quantized latent. The processing of a sample requires usage of its neighbor samples at the above and left direction.

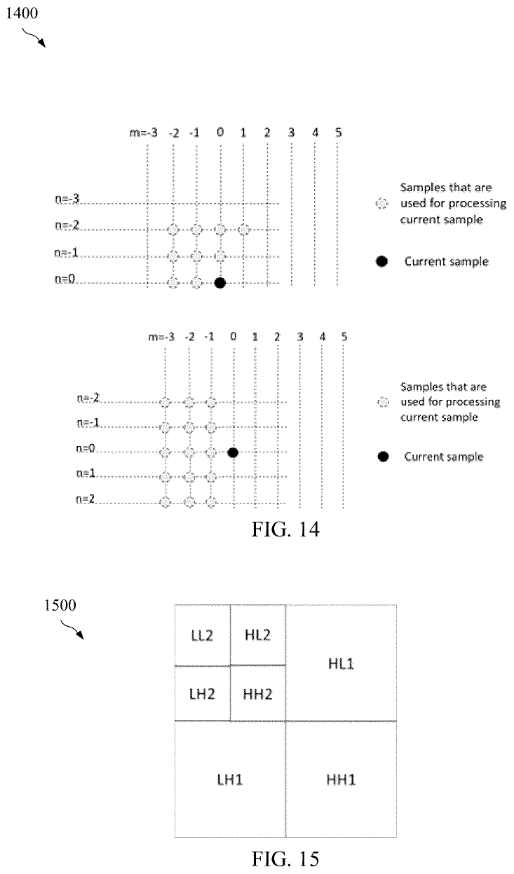

The kernel of the context model can have other shapes. The two other examples are depicted in FIG. 14. FIG. 14 illustrates other example kernels 1400 of an autoregressive network.

When, however, the latent representation comprises samples that have different statistical properties, the efficiency of the autoregressive model deteriorates. Ones such example is depicted below, where the latent representation comprises 7 different regions with different statistical properties. Each region comprises samples that have different frequency components, and hence a sample belonging to region HL1 have very different statistical properties than a sample belonging to region HH1. It is inefficient to predict a sample belonging to region HH1 using samples belonging to HL1.

FIG. 15 illustrates an example latent representation 1500 with multiple regions with different statistical properties. The problem happens when one of the autoregressive network kernels are applied on the latent samples depicted in FIG. 15. Processing of a current sample requires neighbor samples, and when the current sample is comprised in one region and the neighbor sample belongs to another region, the efficiency of prediction deteriorates. The reason is that, since the statistical properties of samples in different regions are different, using one sample in the processing (e.g. prediction) of another sample in a different region is inefficient.

### 4. A Listing of Solutions and Embodiments

The detailed aspects below should be considered as examples to explain general concepts. These aspects should not be interpreted in a narrow way. Furthermore, these aspects can be combined in any manner.

### 4.1 Target of the Examples

The target of the examples is to increase the efficiency of the auto-regressive module by separating the luma and chroma tile partitioning and restricting prediction across the boundaries of predetermined regions.

### 4.2 Central Examples

The central examples govern the processing of latent samples by an autoregressive neural network using separated luma and chroma tile partitioning maps. The partitioning information of luma and chroma tiles and the processing order are specified and signaled in the bitstream. The tile partitioning maps could be used in but not limited to deriving the quantization scales, adjusting the latent domain offsets, etc.

### 4.3 Details

### 4.3.1 Decoding Process

According to the disclosure the decoding of the bitstream to obtain the reconstructed picture is performed as follows. An image decoding method known as “isolated coding”, comprising the steps of:
Obtaining, using a neural network, the quantized luma latent samples are denoted as ŷₗ, and the chroma latent samples are denoted as ŷ_{c}. The current latent sample of luma component ŷₗ[i,j] which may be quantized using a neighbour quantized latent sample ŷₗ[i+m,j+n], if ŷₗ[i+m,j+n] is in the same tile as the current sample. The current latent sample of chroma component ŷ_{c}[i,j] which may be quantized using a neighbour quantized latent sample ŷ_{c}[i+m,j+n], if ŷ_{c}[i+m,j+n] is in the same tile as the current sample. Furthermore, the current latent sample of chroma component ŷ_{c}[i,j] may be quantized using the collated luma sample ŷₗ.
Obtaining, using a neural network, the current latent sample which may be quantized without using ŷₗ[i+m,j+n] and/or ŷ_{c}[i+m,j+n], if ŷₗ[i+m,j+n] and/or ŷ_{c}[i+m,j+n], is not in the same region as the current sample.
   In one example, all indices (i, j, m, n) are integers.
   In one example, the samples in luma and chroma latent code could share the same (i, j, m, n).
   Alternatively, for example, the sample indices in luma and chroma latent code are different.
Obtaining the reconstructed image using the quantized latent ŷ and a synthesis transform network.

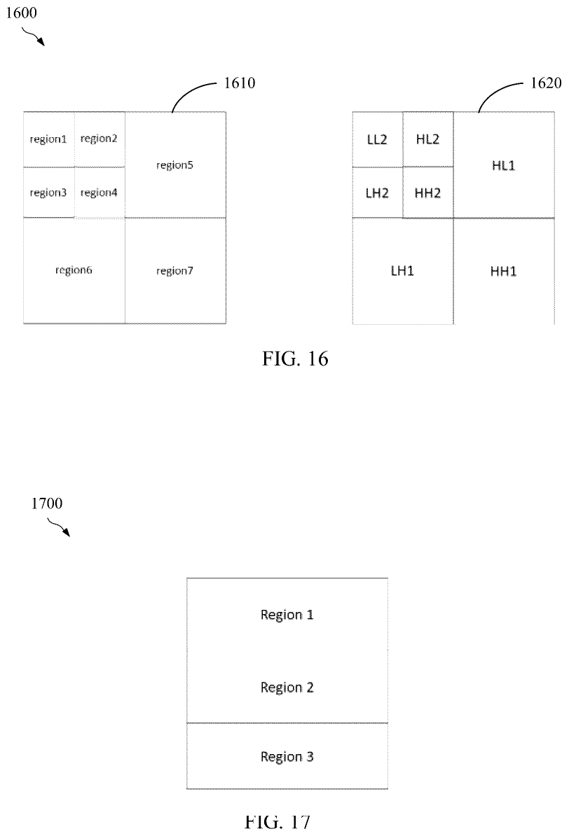

In the decoding process firstly the quantized latent representation is obtained by obtaining its samples (the quantized latent samples). The quantized latent representation might be a tensor or a matrix comprising the quantized latent samples. After the quantized latent samples are obtained, a synthesis transform is applied to obtain the reconstructed image. In particular, the luma latent and chroma latent samples may employ different synthesis transform networks. For obtaining of the quantized latent samples, a tile map is utilized. The tile map is used to divide the quantized latent samples into regions (which could also be called regions). The possible division of the latent representation are exemplified in FIG. 16.

FIG. 16 illustrates an example 1600 tile map according to the disclosure (left) and corresponding wavelet-based transform output (right). According to the first example (the left figure), the latent representation is divided into 7 regions. In this example the region map comprises 3 large rectangle regions and 4 smaller rectangle regions. The smaller 4 rectangle regions correspond to the top-left corner of the latent representation. This example is selected specifically to correspond to the example on FIG. 12 (which is presented in FIG. 16 again, on the right side 1620). In FIG. 12 the latent samples are divided into 7 sections as a result of wavelet-based transformation. The statistical properties of the samples corresponding to each section are quite different, therefore of a sample in one region using a sample from another section would not be efficient. According to the examples, the latent representation is divided into regions that are aligned with the sections generated by the wavelet-based transform.
In one example, the luma and chroma latent codes may employ identical partitioning strategy.
   In one example, one flag is used to indicate whether luma and chroma latent codes employ identical partitioning strategy.
   In one example, whether luma and chroma latent codes employ identical partitioning strategy can be inferred according to the similarity between the luma and chroma latent codes.
   In one example, the partitioning strategy may be quad-tree partitioning, binary-tree partitioning, ternary-tree partitioning.
   In one example, the luma and chroma latent codes are both split with once quad-tree partitioning.
   In one example, luma and chroma latent codes may employ separated indications for the splitting mode.
   In one example, the first flag indicates whether the tile partitioning is enabled. If it is true, the second and the third flags are used to indicate whether luma/chroma and chroma/luma components employ the tile partitioning.
   In one example, only two flags are used for indicating whether luma/chroma and chroma/luma components employ the tile partitioning.
   In one example, the first flag indicates whether the tile partitioning is enabled. If it is true, the second flag is further signaled, representing whether luma and chroma both employ the tile partitioning. If the second flag is false, the third flag is further signaled to indicate whether luma or chroma latent codes employ the tile partitioning.
In one example, the luma latent codes employ the wavelet-based transformation style partitioning, as shown in FIG. 13 left. The chroma latent codes do not further split into sub-tiles.
In one example, the luma latent codes employ the wavelet-based transformation style partitioning, as shown in FIG. 13 left. The chroma latent codes employ the quad-tree or binary-tree partitioning, where four or two identical sub-tiles are generated.
In one example, the luma latent codes employ the wavelet-based transformation style partitioning, as shown in FIG. 13 left. The chroma latent codes employ the recursive partitioning, where the splitting mode and splitting depth will be signaled to the decoder.
In one example, whether to employ the wavelet-based transformation style partitioning will be represented with one flag.
In one example, whether to employ the wavelet-based transformation style partitioning for luma and chroma latent codes will employ separated indications.
In one example, the tile partitioning modes may be determined according to the quantization parameter or target bitrate.
In one example, the tile maps may be applied to the quantized luma and chroma latent codes. The corresponding outputs may the adjusted with the tile partitioning.
   In one example, the latent codes within one tile may be averaged for further usage, including compensation, offset adjustment, etc.
   In one example, the maximum value of the latent code within one tile may be used for further usage, including compensation, offset adjustment, etc.
   In one example, the minimum value of the latent code within one tile may be used for further usage, including compensation, offset adjustment, etc.

FIG. 17 illustrates an example region map 1700. Another example of a region map according to the examples is depicted in FIG. 17. In the figure, the latent representation is divided into N tiles, where N=3. According to the examples, a sample belonging to region 1 is processed only using the samples from region 1. A sample belonging to region 2 is processed using only the samples from region 2 etc. A side benefit of the examples is that the processing of region 1, region 2, and region 3 can be performed in parallel. The luma and chroma latent codes could employ such 3-tiles partitioning such that the regions within luma and chroma latent codes can be independently processed. This is because the processing of samples comprised in region 1 does not depend on the availability of any samples from region 2 or 3. Similarly, samples of region 2 can also be processed independently of other regions. As a result, the three regions can be processed in parallel, which would in turn speed up the processing speed.
In one example, all tiles in luma and chroma latent codes are independent from each other.
In one example, the only the tiles in luma component are independent of each other. The latter coded chroma latent samples may depend on the previously decoded regions in chroma latent codes and/or luma latent codes.
   The dependency of such region based latent coding is indicated with flags for luma and chroma coding.

In other cases, to utilize the information between different regions, the encoding and decoding produce can be in some sequence ways, former decoded regions can be used as the reference of the current region that to be coded.
In one example, the luma and chroma latent codes could employ such N-tiles partitioning. The chroma tile K (0<K<=N) could be dependent on the corresponding luma tile K (0<K<=N).
In one example, the luma and chroma latent codes could employ such N-tiles partitioning. The chroma tile K ((<K<=N) could be dependent on luma tile M (0<M<=K).

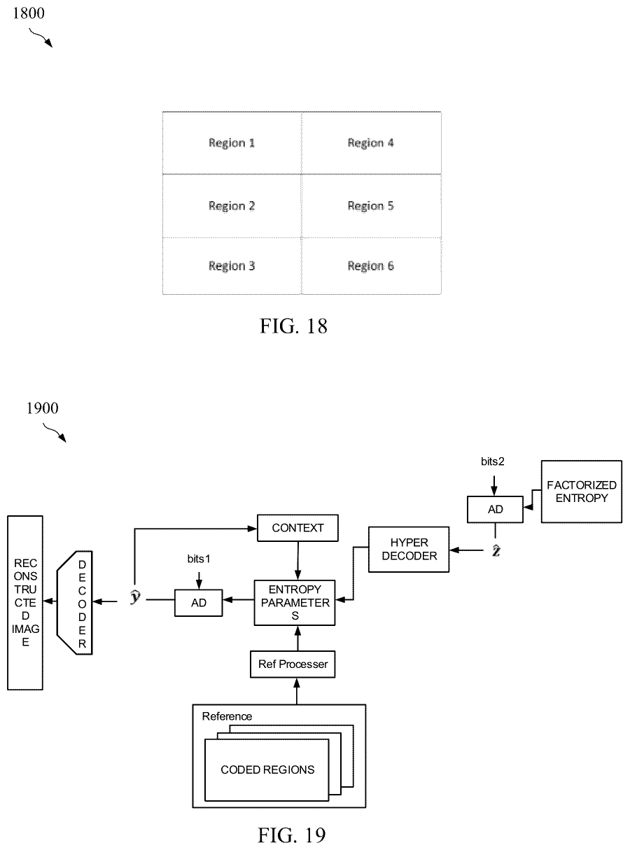

FIG. 18 illustrates another example region map 1800. Another example region map is depicted in FIG. 18. If the neighbour quantized latent samples ŷₗ[i+m,j+n] and ŷ_{c}[i+m,j+n] and the current quantized latent sample ŷₗ[i,j] and ŷ_{c}[i,j] is in the same region is determined based on a region map. As exemplified in the examples above, a current sample in region 2 is obtained using the neighboring sample if the neighbour sample is also in region 2. Otherwise, the current sample is obtained without using the neighbour sample.

According to the examples, the tile map of luma and chroma can be predetermined. Or it can be determined based on indications in the bitstream. The indication might indicate:
1. Numbers of tiles in the luma and chroma tile map that divides the latent representations.
2. Size of the tiles in luma and chroma latent codes.
3. Position of tiles.

The tile map might be obtained according to the size of the luma and chroma latent representation. For example, if the width and height of a luma latent representation are W and H respectively, and if the latent representation is divided into 3 equal sized regions, the width and height of the luma tile might be W and H/3 respectively. Correspondingly, the width and height of the chroma tile might be W/2 and H/6 respectively for 420 color format.

The region map might be obtained based on the size of the reconstructed image. For example, if the width and height of the luma channel of reconstructed image are W and H respectively, and if the latent representation is divided into 3 equal sized regions, the width and height of the luma tile might be W/K and H/(3K) respectively, where K is a predetermined positive integer. Correspondingly, the width and height of the chroma tile might be W/2K and H/(6K) respectively, where K is a predetermined positive integer.

The tile map might be obtained according to depth values, indicating the depths of the luma and chroma synthesis transforms. For example, in FIG. 16 the depth of the wavelet-based transform for luma component is 2. In such an example the tile map might be obtained by first dividing the latent representation into 4 primary rectangles (depth 1) and one of the resulting rectangles are divided into 4 secondary rectangles (corresponding to depth 2). Therefore, the total of 7 regions are obtained according to the depth of the transform that is used (e.g. the wavelet-based transform here). The chroma component could conduct a similar partition procedure.

According to the examples, the probability modeling in entropy coding part can utilize coded group information. An Example of the probability modeling is shown in the FIG. 19.

FIG. 19 illustrates an example utilization of reference information. According to the example of FIG. 19, the reference information can be processed by ref processer network, and then used for the probability modeling of the entropy parameters.

In one example, the ref processor may be composed by convolutional networks.

In one example, the ref processor is using pixel cnn.

In one example, the ref processor may be some down sampling or up sampling method.

In one example, the ref processor can be removed, and the reference information is directly fed into the entropy parameters.

Alternatively, the reference information also can be fed into the hyper decoder.

According to the examples, the synthesis transform or the analysis transform can be wavelet-based transforms.

According to the examples, the luma and chroma components may employ different synthesis transforms or the analysis transforms.

In one example, the isolated coding method may be applied to a first set luma and chroma latent samples (which may be quantized), and/or it may not be applied to a second luma and chroma latent samples (which may be quantized).

In one example, the isolated coding method may be applied to luma and chroma samples (which may be quantized) in a first region, and/or it may not be applied to luma and chroma latent samples (which may be quantized) in a second region.

In one example, the region locations and/or dimensions may be determined depending on color format/color components.

In one example, the region locations and/or dimensions may be determined depending on whether the picture is resized.

In one example, whether and/or how to apply the isolated coding method may depend on the latent sample location.

In one example, whether and/or how to apply the isolated coding method may depend on whether the picture is resized.

In one example, whether and/or how to apply the isolated coding method may depend on color format/color components.

### 4.3.2 Encoding Process

According to the examples, the encoding process follows the same process as the decoding process for obtaining the quantized latent samples. The difference is that, after the quantizes latent samples are obtained, the samples are included in a bitstream using an entropy encoding method.

According to the examples, the encoding of an input image to obtain bitstream is performed as follows. An image encoding method, comprising the steps of:
Obtaining, using a neural network, the quantized luma latent samples are denoted as ŷₗ, and the chroma latent samples are denoted as ŷ_{c}. The current latent sample of luma component ŷₗ[i,j] which may be quantized using a neighbour quantized latent sample ŷₗ[i+m,j+n], if ŷₗ[i+m,j+n] is in the same tile as the current sample. The current latent sample of chroma component ŷ_{c}[i,j] which may be quantized using a neighbour quantized latent sample ŷ_{c}[i+m,j+n], if ŷ_{c}[i+m,j+n] is in the same tile as the current sample. Furthermore, the current latent sample of chroma component ŷ_{c}[i,j] may be quantized using the collated luma sample 91.
Obtaining, using a neural network, the current latent sample which may be quantized without using ŷₗ[i+m,j+n] and/or ŷ_{c}[i+m,j+n], if ŷₗ[i+m,j+n] and/or ŷ_{c}[i+m,j+n], is not in the same region as the current sample.
where all indices (i, j, m, n) are integers, obtaining a bitstream using the quantized latent ŷₗ and ŷ_{c} and an entropy encoding module.

### 4.4 Benefits

The disclosure provides a method of separate the tiling schemes of luma and chroma components, with the aim of improving the efficiency of obtaining and signaling quantized luma and chroma latent samples. Moreover, it allows the full parallel processing of different luma and chroma tiles, indicating that the samples of each tile are processed independently of each other. Moreover, to further improve the coding efficiency, some the luma and chroma tiles or the tiles within luma and chroma latent codes can be coded in a sequential way, which means the former coded tiles can be used as reference to boost the compression ratio of the current tile to be coded.

### 5 Embodiments

1. An image decoding method, comprising the steps of:
   Obtaining, using a neural network, the quantized luma latent samples are denoted as ŷₗ, and the chroma latent samples are denoted as ŷ_{c}. The current latent sample of luma component ŷₗ[i,j] which may be quantized using a neighbour quantized latent sample ŷₗ[i+m,j+n], if ŷₗ[i+m,j+n] is in the same tile as the current sample. The current latent sample of chroma component ŷ_{c}[i,j] which may be quantized using a neighbour quantized latent sample ŷ_{c}[i+m,j+n], if ŷ_{c}[i+m,j+n] is in the same tile as the current sample. Furthermore, the current latent sample of chroma component ŷ_{c}[i,j] may be quantized using the collated luma sample 91.
   Obtaining, using a neural network, the current latent sample which may be quantized without using ŷₗ[i+m,j+n] and/or ŷ_{c}[i+m,j+n], if ŷₗ[i+m,j+n] and/or ŷ_{c}[i+m,j+n], is not in the same region as the current sample.
   Obtaining the reconstructed image using the quantized latent ŷₗ and ŷ_{c}, with a synthesis transform network, where all indices (i, j, m, n) are integers.
2. An image encoding method, comprising the steps of:
   Obtaining a latent sample using an analysis transform, where the luma and chroma components may employ the same or separated analysis transform networks.
   Obtaining the quantized latent ŷₗ and ŷ_{c} by using the steps below;
   Obtaining, using a neural network, the quantized luma latent samples are denoted as ŷₗ, and the chroma latent samples are denoted as ŷ_{c}. The current latent sample of luma component ŷₗ[i,j] which may be quantized using a neighbour quantized latent sample ŷₗ[i+m,j+n], if ŷₗ[i+m,j+n] is in the same tile as the current sample. The current latent sample of chroma component ŷ_{c}[i,j] which may be quantized using a neighbour quantized latent sample ŷ_{c}[i+m,j+n], if ŷ_{c}[i+m,j+n] is in the same tile as the current sample. Furthermore, the current latent sample of chroma component ŷ_{c}[i,j] may be quantized using the collated luma sample ŷₗ.
   Obtaining, using a neural network, the current latent sample which may be quantized without using ŷₗ[i+m,j+n] and/or ŷ_{c}[i+m,j+n], if ŷₗ[i+m,j+n] and/or ŷ_{c}[i+m,j+n], is not in the same region as the current sample.
   Obtaining the reconstructed image using the quantized latent ŷₗ and ŷ_{c}, with a synthesis transform network, where all indices (i, j, m, n) are integers.
3. According to solution 1 or 2, Determination of if the neighbour quantized latent sample ŷ[i+m,j+n] and the current quantized latent sample ŷ[i,j] regarding the luma latent codes is in the same tile is performed based on the tile map. Determination of if ŷ_{c}[i,j] is dependent or independent to ŷ[i,j] is based on whether luma and chroma latent codes employ separate tile maps.
4. According to solution 3, The tile maps of luma and chroma latent codes are predetermined.
5. According to solution 3 or 4, the tile maps of luma and chroma latent codes are obtained according to indications in the bitstream.
6. According to solution 3, 4 or 5, the tile maps of luma and chroma latent codes are obtained according to the width and height of the quantized latent representation, which is a matrix or tensor that comprises quantized latent samples.
7. According to all solutions above, the tile maps of luma and chroma latent codes are obtained according to the width and height of the reconstructed image.
8. According to all solutions above, the tile maps of luma and chroma latent codes are obtained according to depth values, indicating the depths of the luma and chroma synthesis transform processes.
9. According to all solutions above, the tile maps of luma and chroma latent codes are obtained by first dividing the quantized latent representation into 4 primary rectangular regions, and dividing the first primary rectangular region further into 4 secondary rectangular regions. This could be conducted to both luma and chroma latent codes. Alternatively, this could be applied to only luma or only chroma latent codes.
10. According to solution 9, the first primary rectangular region is the top-left primary rectangular region of luma and/or chroma latent codes.
11. According to solution 9 or 10, not dividing the remaining 3 primary rectangular regions into secondary regions in luma and/or chroma latent codes.
12. According to all solutions above, the region map is obtained according to depth values of luma transform network and chroma transform network.
13. According to all solutions above, obtaining, using a neural network, the current quantized latent sample based on at least one padded sample if ŷ[i+m,j+n] is not in the same region as the current sample.
14. According to solution 13, the said padded sample has a predetermined value.
15. According to solution 14, the predetermined value is a constant value.
16. According to solution 15, the predetermined value is equal to 0.
17. According to all solutions above, the said neural network is an auto-regressive neural network.
18. According to all solutions above, the synthesis transform or the analysis transform is wavelet-based transforms.

As used herein, the term “video unit” or “video block” may be a sequence, a picture, a slice, a tile, a brick, a subpicture, a coding tree unit (CTU)/coding tree block (CTB), a CTU/CTB row, one or multiple coding units (CUs)/coding blocks (CBs), one ore multiple CTUs/CTBs, one or multiple Virtual Pipeline Data Unit (VPDU), a sub-region within a picture/slice/tile/brick. The term “luma latent code”/“luma latent representation” used herein may refer to a set of luma latent samples. The term “chroma latent code”/“chroma latent representation” used herein may refer to a set of chroma latent samples. The term “latent sample”/“latent representation” used herein may include luma latent sample and chroma latent sample.

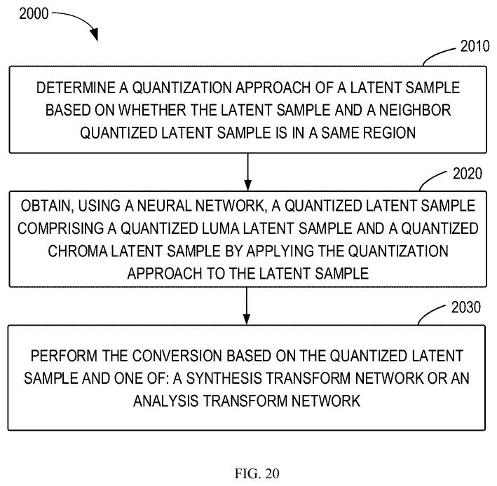

FIG. 20 illustrates a flowchart of a method 2000 for video processing in accordance with embodiments of the present disclosure. The method 200 is implemented during a conversion between a target video block of a video and a bitstream of the video.

At block 2010, for a conversion between a video unit of a video and a bitstream of the video, a quantization approach of a latent sample is determined based on whether the latent sample and a neighbor quantized latent sample is in a same region.

At block 2020, a quantized latent sample comprising a quantized luma latent sample and a quantized chroma latent sample is obtained, using a neural network, by applying the quantization approach to the latent sample. In some embodiments, the neural network is an auto-regressive neural network.

In some embodiments, obtaining the quantized latent sample comprising the quantized luma latent sample and the quantized chroma latent sample includes: in accordance with a determination that a neighbor quantized luma latent sample is in the same region as a luma latent sample, obtaining the quantized luma latent sample using the neighbor quantized luma latent sample. In some embodiments, obtaining the quantized latent sample comprising the quantized luma latent sample and the quantized chroma latent sample includes: in accordance with a determination that a neighbor quantized chroma latent sample is in the same region as a chroma latent sample, obtaining the quantized chroma latent sample using the neighbor quantized chroma latent sample. For example, the quantized luma latent samples which are denoted as ŷₗ, and the quantized chroma latent samples which are denoted as ŷ_{c} are obtained using the neural network. The current latent sample of luma component ŷₗ[i,j] which may be quantized using a neighbour quantized latent sample ŷₗ[i+m,j+n], if ŷₗ[i+m,j+n] is in the same tile as the current sample. The current latent sample of chroma component ŷ_{c}[i,j] which may be quantized using a neighbour quantized latent sample ŷ_{c}[i+m,j+n], if ŷ_{c}[i+m,j+n] is in the same tile as the current sample. Furthermore, the current latent sample of chroma component ŷ_{c}[i,j] may be quantized using the collated luma sample ŷₗ.

In some embodiments, obtaining the quantized latent sample comprising the quantized luma latent sample and the quantized chroma latent sample includes: in accordance with a determination that a neighbor quantized luma latent sample is not in the same region as a luma latent sample, obtaining the quantized luma latent sample without using the neighbor quantized luma latent sample. In some embodiments, obtaining the quantized latent sample comprising the quantized luma latent sample and the quantized chroma latent sample includes: in accordance with a determination that a neighbor quantized chroma latent sample is not in the same region as a chroma latent sample, obtaining the quantized chroma latent sample without using the neighbor quantized chroma latent sample. For example, the current latent sample which may be quantized without using ŷₗ[i+m,j+n] and/or ŷ_{c}[i+m,j+n] may be obtained using a neural network, if ŷₗ[i+m,j+n] and/or ŷ_{c}[i+m,j+n], is not in the same region (or tile) as the current sample. In some embodiments, all indices associated with the neighbor quantized latent sample integers. In one example, all indices (i, j, m, n) are integers. In one example, the samples in luma and chroma latent code could share the same (i, j, m, n). Alternatively, for example, the sample indices in luma and chroma latent code are different.

In some embodiments, obtaining the quantized latent sample comprising the quantized luma latent sample and the quantized chroma latent sample includes: in accordance with a determination that a neighbor quantized latent sample is not in the same region as the latent sample, obtaining the quantized latent sample based on at least one padded sample. In some embodiments, the at least one padded sample has a predetermined value. In some embodiments, the predetermined value is a constant value. In some embodiments, the predetermined value equals to 0.

In some embodiments, obtaining the quantized latent sample comprising the quantized luma latent sample and the quantized chroma latent sample includes: obtaining the quantized chroma latent sample using the quantized luma latent sample.

At block 2030, the conversion is performed based on the quantized latent sample and one of: a synthesis transform network or an analysis transform network. For example, the reconstructed image may be obtained using the quantized latent ŷ and a synthesis transform network. Alternatively, a bitstream may be obtained using the quantized latent ŷₗ and ŷ_{c} and an entropy encoding module. In some embodiments, the quantized luma latent sample and the quantized chroma latent sample employ separated synthesis transform networks. In some embodiments, a luma component and chroma components of the latent sample employ a set of same analysis transform networks or separated analysis transform networks.

In this way, it can improve the efficiency of obtaining and signaling quantized luma and chroma latent samples. Moreover, it allows the full parallel processing of different luma and chroma tiles, indicating that the samples of each tile are processed independently of each other. Moreover, to further improve the coding efficiency, some the luma and chroma tiles or the tiles within luma and chroma latent codes can be coded in a sequential way, which means the former coded tiles can be used as reference to boost the compression ratio of the current tile to be coded.

In some embodiments, a quantized latent representation is a tensor comprising a plurality of quantized latent samples. Alternatively, the quantized latent representation is a matrix comprising the plurality of quantized latent samples. In the decoding process firstly the quantized latent representation is obtained by obtaining its samples (the quantized latent samples). The quantized latent representation might be a tensor or a matrix comprising the quantized latent samples. After the quantized latent samples are obtained, a synthesis transform is applied to obtain the reconstructed image. In particular, the luma latent and chroma latent samples may employ different synthesis transform networks. For obtaining of the quantized latent samples, a tile map is utilized. The tile map is used to divide the quantized latent samples into regions (which could also be called regions).

In some embodiments, the tile map is used to divide the quantized latent representation into a plurality of regions. In some embodiments, the quantized latent representation is divided into 7 regions. The possible division of the latent representation may be shown in FIG. 16 where illustrates an example tile map according to the embodiments (1610) and corresponding wavelet-based transform output (1620).

According to the first example (shown as 1610 in FIG. 16), the latent representation is divided into 7 regions. In this example the region map may include 3 large rectangle regions and 4 smaller rectangle regions. The smaller 4 rectangle regions correspond to the top-left corner of the latent representation. This example is selected specifically to correspond to the example on FIG. 12 (which is presented in FIG. 16 again, on the right side 1620). In FIG. 12 the latent samples are divided into 7 sections as a result of wavelet-based transformation. As mentioned above, the statistical properties of the samples corresponding to each section are quite different, therefore of a sample in one region using a sample from another section would not be efficient. According to the embodiments the latent representation is divided into regions that are aligned with the sections generated by the wavelet-based transform.

In some embodiments, the quantized luma latent sample and the quantized chroma latent sample employ an identical partitioning strategy. In some embodiments, a flag is used to indicate whether the quantized luma latent sample and the quantized chroma latent sample employ the identical partitioning strategy. Alternatively, whether the quantized luma latent sample and the quantized chroma latent sample employ an identical partitioning strategy is inferred according to a similarity between the quantized luma latent sample and the quantized chroma latent sample.

In some embodiments, the identical partitioning strategy comprises one of: a quad-tree partitioning, a binary-tree partitioning, or a ternary-tree partitioning. In some embodiments, the quantized luma latent sample and the quantized chroma latent sample are both split with once quad-tree partitioning.

In some embodiments, the quantized luma latent sample and the quantized chroma latent sample employ separated indications for a splitting mode. In some embodiments, a first flag indicates whether a tile partitioning is enabled. In some embodiments, if the first flag indicates the tile portioning is enabled, a second flag is used to indicate whether a luma component employs the tile partitioning, and a third flag is used to indicate whether a chroma component employs the tile partitioning, and/or where if the first flag indicates the tile portioning is enabled, a second flag is further indicated to indicate whether luma and chroma components both employ the tile partitioning, and/or if the second flag indicates not luma and chroma components both employ the tile partitioning, a third flag is further indicated to indicate whether a luma component or a chroma component employ the tile partitioning. In some embodiments, one flag is used to indicate whether a luma component employs the tile partitioning, and another flag is used to indicate whether a chroma component employs the tile partitioning.

In some embodiments, a luma latent sample employs a wavelet-based transformation style partitioning, and a chroma latent sample does not further split into sub-tiles. In one example, the luma latent codes employ the wavelet-based transformation style partitioning, as shown in 1620 in FIG. 16. The chroma latent codes may not further split into sub-tiles.

In some embodiments, a luma latent sample employs a wavelet-based transformation style partitioning, and a chroma latent sample employs the quad-tree partitioning where four identical sub-tiles are generated or a binary-tree partitioning where two identical sub-tiles are generated. In one example, the luma latent codes employ the wavelet-based transformation style partitioning, as shown in 1610 in FIG. 16. The chroma latent codes may employ the quad-tree or binary-tree partitioning, where four or two identical sub-tiles are generated.

In some embodiments, a luma latent sample employs a wavelet-based transformation style partitioning, and a chroma latent sample employs a recursive partitioning, where a splitting mode and a splitting depth are indicated to a decoder. In one example, the luma latent codes employ the wavelet-based transformation style partitioning, as shown in 1610 in FIG. 16. The chroma latent codes may employ the recursive partitioning, where the splitting mode and splitting depth may be signaled to the decoder.

In some embodiments, whether to employ the wavelet-based transformation style partitioning is indicated with one flag. In some embodiments, whether to employ the wavelet-based transformation style partitioning for luma and chroma latent samples employ separated indications.

In some embodiments, tile partitioning modes are determined according to a quantization parameter or target bitrate. In some embodiments, tile maps are applied to the quantized luma latent sample and the quantized chroma latent sample, corresponding outputs are adjusted with tile partitioning.

In some embodiments, the latent sample within one tile is averaged for further usage which includes a compensation, or an offset adjustment. In some embodiments, a maximum value of the latent sample within one tile is used for further usage which includes a compensation, or an offset adjustment. In some embodiments, a minimum value of the latent sample within one tile is used for further usage which includes a compensation, or an offset adjustment.

In some embodiments, the quantized latent representation is divided into N tiles, where N equals to 3, luma and chroma latent sample employ 3 tiles partitioning such that the tiles within luma and chroma latent sample are independently processed. In this way, it allows the full parallel processing of different luma and chroma tiles, indicating that the samples of each tile are processed independently of each other.

An example of a region map according to example embodiments the disclosure is depicted in FIG. 17. In FIG. 17, the latent representation is divided into N tiles, where N=3. According to the present disclosure, a sample belonging to region 1 is processed only using the samples from region 1. A sample belonging to region 2 is processed using only the samples from region 2 etc. A side benefit of example embodiments of the disclosure is that the processing of region 1, region 2, and region 3 can be performed in parallel. The luma and chroma latent codes could employ such 3-tiles partitioning such that the regions within luma and chroma latent codes can be independently processed. This is because the processing of samples comprised in region 1 does not depend on the availability of any samples from region 2 or 3. Similarly, samples of region 2 can also be processed independently of other regions. As a result, the three regions can be processed in parallel, which would in turn speed up the processing speed.

In some embodiments, all tiles in luma and chroma latent samples are independent from each other. In some embodiments, only tiles in luma components are independent of each other. In some embodiments, latter coded chroma latent samples depend on previously decoded regions in at least one of: chroma latent samples or luma latent samples. In some embodiments, a dependency of a region based latent coding is indicated with flags for luma and chroma coding.

In some embodiments, luma and chroma latent samples employ N-tiles partitioning, where N is an integer number. In some embodiments, chroma tile K is dependent on a corresponding luma tile K, where K is larger than zero and not larger than N. In some embodiments, chroma tile K is dependent on luma tile M, where K is larger than zero and not larger than N, and M is larger than zero and not larger than K.

In some embodiments, if the neighbour quantized latent samples ŷₗ[i+m,j+n] and ŷ_{c}[i+m,j+n] and the current quantized latent sample ŷₗ[i,j] and ŷ_{c}[i,j] is in the same region may be determined based on a region map. As shown in FIG. 18, a current sample in region 2 is obtained using the neighboring sample if the neighbour sample is also in region 2. Otherwise, the current sample is obtained without using.

In some embodiments, the tile map of luma and chroma samples is predetermined. In some embodiments, the tile map is determined based on at least one indication in the bitstream. In some embodiments, the at least one indication indicates one or more of: the numbers of tiles in the tile map that divides the latent sample, a size of the tiles in luma latent sample and chroma latent sample, or position of tiles.

In some embodiments, the tile map is obtained according to a size of the quantized latent representation which is a matrix or tensor that comprises quantized latent samples. In some embodiments, if a width and height of a luma latent representation are W and H respectively, and if the quantized latent representation is divided into 3 equal sized regions, a width and height of a luma tile is W and H/3 respectively, and a width and height of a chroma tile is W/2 and H/6 respectively for 420 color format.

In some embodiments, the region map is obtained based on a size of the reconstructed image. In some embodiments, if a width and height of a luma channel of the reconstructed image are W and H respectively, and if the latent representation is divided into 3 equal sized regions, a width and height of a luma tile is W/K and H/(3K) respectively, where K is a predetermined positive integer, and a width and height of a chroma tile is W/2K and H/(6K) respectively, where K is a predetermined positive integer.

In some embodiments, a tile map is obtained according to depth values that indicates depths of luma and chroma synthesis transforms. In some embodiments, the tile map of the quantized latent representation is obtained by first dividing the quantized latent representation into 4 primary rectangular regions and dividing the first primary rectangular region further into 4 secondary rectangular regions. The quantized latent representation may include at least one of: a luma latent sample or a chroma latent sample. In some embodiments, the first primary rectangular region is a top-left primary rectangular region of at least one of: the luma or chroma latent sample. For example, in FIG. 16, the depth of the wavelet-based transform for luma component is 2. In such an example the tile map might be obtained by first dividing the latent representation into 4 primary rectangles (depth 1) and one of the resulting rectangles are divided into 4 secondary rectangles (corresponding to depth 2). Therefore, the total of 7 regions are obtained according to the depth of the transform that is used (e.g. the wavelet-based transform here). The chroma component could conduct a similar partition procedure.

In some embodiments, the method 2000 further comprises: skipping dividing remaining 3 primary rectangular regions into secondary regions in at least one of: the luma or chroma latent sample. In some embodiments, the region map is obtained according to depth values of luma transform network and chroma transform network.

In some embodiments, a probability modeling in entropy coding part utilizes coded group information. Example of the probability modeling is shown in FIG. 20. According to the example of FIG. 20, the reference information can be processed by reference processer network, and then used for the probability modeling of the entropy parameters.

In some embodiments, reference information is processed by a reference processer network, and then used for the probability modeling of entropy parameters. In some embodiments, the reference processor is composed by convolutional networks. Alternatively, the reference processor is using pixel cnn. In some example embodiments, the reference processor is down sampling or up sampling method.

In some embodiments, the reference processor is removed, and the reference information is directly fed into the entropy parameters. In some embodiments, the reference information is also fed into a hyper decoder.

In some embodiments, the synthesis transform or the analysis transform are wavelet-based transforms. In some embodiments, luma and chroma components employ different synthesis transforms or the analysis transforms.

In some embodiments, performing the conversion based on the quantized latent sample and the synthesis transform network or the analysis transform network is applied to a first set luma and chroma latent samples. Alternatively, or in addition, performing the conversion based on the quantized latent sample and the synthesis transform network or the analysis transform network is not applied to a second luma and chroma latent samples.

In some embodiments, performing the conversion based on the quantized latent sample and the synthesis transform network or the analysis transform network is applied to luma and chroma samples in a first region. Alternatively, or in addition, performing the conversion based on the quantized latent sample and the synthesis transform network or the analysis transform network is not applied to luma and chroma latent samples in a second region.

In some embodiments, at least one of: region locations or dimensions is determined depending on color format or color components. In some embodiments, at least one of: region locations or dimensions is determined depending on whether a picture is resized.

In some embodiments, whether and/or how to perform the conversion based on the quantized latent sample and the synthesis transform network or the analysis transform network depends on the latent sample location. In some embodiments, whether and/or how to perform the conversion based on the quantized latent sample and the synthesis transform network or the analysis transform network depends on whether the picture is resized. In some embodiments, whether and/or how to perform the conversion based on the quantized latent sample and the synthesis transform network or the analysis transform network depends on color format or color components.

According to further embodiments of the present disclosure, a non-transitory computer-readable recording medium is provided. The non-transitory computer-readable recording medium stores a bitstream of a video which is generated by a method performed by an apparatus for video processing. The method comprises: determining a quantization approach of a latent sample of a video unit based on whether the latent sample and a neighbor quantized latent sample is in a same region; obtaining, using a neural network, a quantized latent sample comprising a quantized luma latent sample and a quantized chroma latent sample by applying the quantization approach to the latent sample; and generating the bitstream based on the quantized latent sample.

According to still further embodiments of the present disclosure, a method for storing bitstream of a video is provided. The method comprises: determining a quantization approach of a latent sample of a video unit based on whether the latent sample and a neighbor quantized latent sample is in a same region; obtaining, using a neural network, a quantized latent sample comprising a quantized luma latent sample and a quantized chroma latent sample by applying the quantization approach to the latent sample; generating the bitstream based on the quantized latent sample; and storing the bitstream in a non-transitory computer-readable recording medium.

Implementations of the present disclosure can be described in view of the following clauses, the features of which can be combined in any reasonable manner.
Clause 1. A method of video processing, comprising: determining, for a conversion between a video unit of a video and a bitstream of the video, a quantization approach of a latent sample based on whether the latent sample and a neighbor quantized latent sample is in a same region; obtaining, using a neural network, a quantized latent sample comprising a quantized luma latent sample and a quantized chroma latent sample by applying the quantization approach to the latent sample; and performing the conversion based on the quantized latent sample and one of: a synthesis transform network or an analysis transform network.
Clause 2. The method of clause 1, wherein obtaining the quantized latent sample comprising the quantized luma latent sample and the quantized chroma latent sample comprises: in accordance with a determination that a neighbor quantized luma latent sample is in the same region as a luma latent sample, obtaining the quantized luma latent sample using the neighbor quantized luma latent sample.
Clause 3. The method of clause 1, wherein obtaining the quantized latent sample comprising the quantized luma latent sample and the quantized chroma latent sample comprises: in accordance with a determination that a neighbor quantized chroma latent sample is in the same region as a chroma latent sample, obtaining the quantized chroma latent sample using the neighbor quantized chroma latent sample.
Clause 4. The method of clause 1, wherein obtaining the quantized latent sample comprising the quantized luma latent sample and the quantized chroma latent sample comprises: in accordance with a determination that a neighbor quantized luma latent sample is not in the same region as a luma latent sample, obtaining the quantized luma latent sample without using the neighbor quantized luma latent sample.
Clause 5. The method of clause 1, wherein obtaining the quantized latent sample comprising the quantized luma latent sample and the quantized chroma latent sample comprises: in accordance with a determination that a neighbor quantized chroma latent sample is not in the same region as a chroma latent sample, obtaining the quantized chroma latent sample without using the neighbor quantized chroma latent sample.
Clause 6. The method of clause 1, wherein obtaining the quantized latent sample comprising the quantized luma latent sample and the quantized chroma latent sample comprises: in accordance with a determination that a neighbor quantized latent sample is not in the same region as the latent sample, obtaining the quantized latent sample based on at least one padded sample.
Clause 7. The method of clause 6, wherein the at least one padded sample has a predetermined value.
Clause 8. The method of clause 7, wherein the predetermined value is a constant value.
Clause 9. The method of clause 8, wherein the predetermined value equals to 0.
Clause 10. The method of clause 1, wherein obtaining the quantized latent sample comprising the quantized luma latent sample and the quantized chroma latent sample comprises: obtaining the quantized chroma latent sample using the quantized luma latent sample.
Clause 11. The method of clause 1, wherein a quantized latent representation is a tensor comprising a plurality of quantized latent samples, or wherein the quantized latent representation is a matrix comprising the plurality of quantized latent samples.
Clause 12. The method of any of clauses 1-11, further comprising: obtaining a reconstructed image using the quantized luma latent sample and the quantized chroma latent sample with a synthesis transform network, wherein all indices associated with the neighbor quantized latent sample integers.
Clause 13. The method of clause 12, wherein the quantized luma latent sample and the quantized chroma latent sample employ separated synthesis transform networks.
Clause 14. The method of any of clauses 1-13, further comprising obtaining the latent sample using an analysis transform, wherein a luma component and chroma components of the latent sample employ a set of same analysis transform networks or separated analysis transform networks.
Clause 15. The method of any of clauses 1-14, further comprising: determining whether the latent sample and the neighbor quantized latent sample is in a same region based on a tile map or a region map, and wherein the tile map is used to divide the quantized latent representation into a plurality of regions.
Clause 16. The method of clause 15, wherein the quantized latent representation is divided into 7 regions.
Clause 17. The method of any of clauses 1-16, wherein the quantized luma latent sample and the quantized chroma latent sample employ an identical partitioning strategy.
Clause 18. The method of clause 17, wherein a flag is used to indicate whether the quantized luma latent sample and the quantized chroma latent sample employ the identical partitioning strategy, or wherein whether the quantized luma latent sample and the quantized chroma latent sample employ an identical partitioning strategy is inferred according to a similarity between the quantized luma latent sample and the quantized chroma latent sample.
Clause 19. The method of any of clauses 17-18, wherein the identical partitioning strategy comprises one of: a quad-tree partitioning, a binary-tree partitioning, or a ternary-tree partitioning.
Clause 20. The method of any of clauses 17-18, wherein the quantized luma latent sample and the quantized chroma latent sample are both split with once quad-tree partitioning.
Clause 21. The method of any of clauses 1-16, wherein the quantized luma latent sample and the quantized chroma latent sample employ separated indications for a splitting mode.
Clause 22. The method of clause 21, wherein a first flag indicates whether a tile partitioning is enabled.
Clause 23. The method of clause 22, wherein if the first flag indicates the tile portioning is enabled, a second flag is used to indicate whether a luma component employs the tile partitioning, and a third flag is used to indicate whether a chroma component employs the tile partitioning, and/or wherein if the first flag indicates the tile portioning is enabled, a second flag is further indicated to indicate whether luma and chroma components both employ the tile partitioning, and/or if the second flag indicates not luma and chroma components both employ the tile partitioning, a third flag is further indicated to indicate whether a luma component or a chroma component employ the tile partitioning.
Clause 24. The method of clause 21, wherein one flag is used to indicate whether a luma component employs the tile partitioning, and another flag is used to indicate whether a chroma component employs the tile partitioning.
Clause 25. The method of any of clauses 1-16, wherein a luma latent sample employs a wavelet-based transformation style partitioning, and a chroma latent sample does not further split into sub-tiles.
Clause 26. The method of any of clauses 1-16, wherein a luma latent sample employs a wavelet-based transformation style partitioning, and a chroma latent sample employs the quad-tree partitioning where four identical sub-tiles are generated or a binary-tree partitioning where two identical sub-tiles are generated.
Clause 27. The method of any of clauses 1-16, wherein a luma latent sample employs a wavelet-based transformation style partitioning, and a chroma latent sample employs a recursive partitioning, wherein a splitting mode and a splitting depth are indicated to a decoder.
Clause 28. The method of any of clauses 1-16, wherein whether to employ the wavelet-based transformation style partitioning is indicated with one flag.
Clause 29. The method of clause 28, wherein whether to employ the wavelet-based transformation style partitioning for luma and chroma latent samples employ separated indications.
Clause 30. The method of any of clauses 1-16, wherein tile partitioning modes are determined according to a quantization parameter or target bitrate.
Clause 31. The method of any of clauses 1-16, wherein tile maps are applied to the quantized luma latent sample and the quantized chroma latent sample, corresponding outputs are adjusted with tile partitioning.
Clause 32. The method of clause 31, wherein the latent sample within one tile is averaged for further usage which includes a compensation, or an offset adjustment.
Clause 33. The method of clause 31, wherein a maximum value of the latent sample within one tile is used for further usage which includes a compensation, or an offset adjustment.
Clause 34. The method of clause 31, wherein a minimum value of the latent sample within one tile is used for further usage which includes a compensation, or an offset adjustment.
Clause 35. The method of any of clauses 1-34, wherein the quantized latent representation is divided into N tiles, wherein N equals to 3, luma and chroma latent sample employ 3 tiles partitioning such that the tiles within luma and chroma latent sample are independently processed.
Clause 36. The method of any of clauses 1-35, wherein all tiles in luma and chroma latent samples are independent from each other.
Clause 37. The method of any of clauses 1-35, wherein only tiles in luma components are independent of each other.
Clause 38. The method of clause 37, wherein latter coded chroma latent samples depend on previously decoded regions in at least one of: chroma latent samples or luma latent samples.
Clause 39. The method of clause 37, wherein a dependency of a region based latent coding is indicated with flags for luma and chroma coding.
Clause 40. The method of any of clauses 1-34, wherein luma and chroma latent samples employ N-tiles partitioning, wherein N is an integer number.
Clause 41. The method of clause 40, wherein chroma tile K is dependent on a corresponding luma tile K, wherein K is larger than zero and not larger than N.
Clause 42. The method of clause 40, wherein chroma tile K is dependent on luma tile M, wherein K is larger than zero and not larger than N, and M is larger than zero and not larger than K.
Clause 43. The method of any of clauses 1-42, wherein the tile map of luma and chroma samples is predetermined.
Clause 44. The method of any of clauses 1-42, wherein the tile map is determined based on at least one indication in the bitstream.
Clause 45. The method of clause 44, wherein the at least one indication indicates one or more of: the numbers of tiles in the tile map that divides the latent sample, a size of the tiles in luma latent sample and chroma latent sample, or position of tiles.
Clause 46. The method of any of clauses 1-45, wherein the tile map is obtained according to a size of the quantized latent representation which is a matrix or tensor that comprises quantized latent samples.
Clause 47. The method of clause 46, wherein if a width and height of a luma latent representation are W and H respectively, and if the quantized latent representation is divided into 3 equal sized regions, a width and height of a luma tile is W and H/3 respectively, and a width and height of a chroma tile is W/2 and H/6 respectively for 420 color format.
Clause 48. The method of any of clauses 1-47, wherein the region map is obtained based on a size of the reconstructed image.
Clause 49. The method of clause 48, wherein if a width and height of a luma channel of the reconstructed image are W and H respectively, and if the latent representation is divided into 3 equal sized regions, a width and height of a luma tile is W/K and H/(3K) respectively, wherein K is a predetermined positive integer, and a width and height of a chroma tile is W/2K and H/(6K) respectively, wherein K is a predetermined positive integer.
Clause 50. The method of any of clauses 1-49, wherein a tile map is obtained according to depth values that indicates depths of luma and chroma synthesis transforms.
Clause 51. The method of clause 50, wherein the tile map of the quantized latent representation is obtained by first dividing the quantized latent representation into 4 primary rectangular regions and dividing the first primary rectangular region further into 4 secondary rectangular regions, wherein the quantized latent representation comprises at least one of: a luma latent sample or a chroma latent sample.
Clause 52. The method of clause 51, wherein the first primary rectangular region is a top-left primary rectangular region of at least one of: the luma or chroma latent sample.
Clause 53. The method of any of clauses 51 or 52, further comprising: skipping dividing remaining 3 primary rectangular regions into secondary regions in at least one of: the luma or chroma latent sample.
Clause 54. The method of any of clauses 1-49, wherein the region map is obtained according to depth values of luma transform network and chroma transform network.
Clause 55. The method of any of clauses 1-54, wherein a probability modeling in entropy coding part utilizes coded group information.
Clause 56. The method of clause 55, wherein reference information is processed by a reference processer network, and then used for the probability modeling of entropy parameters.
Clause 57. The method of clause 56, wherein the reference processor is composed by convolutional networks, or the reference processor is using pixel cnn, or the reference processor is down sampling or up sampling method.
Clause 58. The method of clause 56, wherein the reference processor is removed, and the reference information is directly fed into the entropy parameters, and/or wherein the reference information is also fed into a hyper decoder.
Clause 59. The method of any of clauses 1-58, wherein the synthesis transform or the analysis transform are wavelet-based transforms.
Clause 60. The method of any of clauses 1-59, wherein luma and chroma components employ different synthesis transforms or the analysis transforms.
Clause 61. The method of any of clauses 1-60, wherein performing the conversion based on the quantized latent sample and the synthesis transform network or the analysis transform network is applied to a first set luma and chroma latent samples, and/or wherein performing the conversion based on the quantized latent sample and the synthesis transform network or the analysis transform network is not applied to a second luma and chroma latent samples.
Clause 62. The method of any of clauses 1-60, wherein performing the conversion based on the quantized latent sample and the synthesis transform network or the analysis transform network is applied to luma and chroma samples in a first region, and/or wherein performing the conversion based on the quantized latent sample and the synthesis transform network or the analysis transform network is not applied to luma and chroma latent samples in a second region.
Clause 63. The method of any of clauses 1-62, wherein at least one of: region locations or dimensions is determined depending on color format or color components.
Clause 64. The method of any of clauses 1-62, wherein at least one of: region locations or dimensions is determined depending on whether a picture is resized.
Clause 65. The method of any of clauses 1-64, wherein whether and/or how to perform the conversion based on the quantized latent sample and the synthesis transform network or the analysis transform network depends on the latent sample location.
Clause 66. The method of any of clauses 1-64, wherein whether and/or how to perform the conversion based on the quantized latent sample and the synthesis transform network or the analysis transform network depends on whether the picture is resized.
Clause 67. The method of any of clauses 1-64, wherein whether and/or how to perform the conversion based on the quantized latent sample and the synthesis transform network or the analysis transform network depends on color format or color components.
Clause 68. The method of any of clauses 1-67, wherein the neural network is an auto-regressive neural network.
Clause 69. The method of any of clauses 1-68, wherein the conversion includes encoding the video unit into the bitstream.
Clause 70. The method of any of clauses 1-68, wherein the conversion includes decoding the video unit from the bitstream.
Clause 71. An apparatus for video processing comprising a processor and a non-transitory memory with instructions thereon, wherein the instructions upon execution by the processor, cause the processor to perform a method in accordance with any of clauses 1-70.
Clause 72. A non-transitory computer-readable storage medium storing instructions that cause a processor to perform a method in accordance with any of clauses 1-70.
Clause 73. A non-transitory computer-readable recording medium storing a bitstream of a video which is generated by a method performed by an apparatus for video processing, wherein the method comprises: determining a quantization approach of a latent sample of a video unit based on whether the latent sample and a neighbor quantized latent sample is in a same region; obtaining, using a neural network, a quantized latent sample comprising a quantized luma latent sample and a quantized chroma latent sample by applying the quantization approach to the latent sample; and generating the bitstream based on the quantized latent sample.
Clause 74. A method for storing a bitstream of a video, comprising: determining a quantization approach of a latent sample of a video unit based on whether the latent sample and a neighbor quantized latent sample is in a same region; obtaining, using a neural network, a quantized latent sample comprising a quantized luma latent sample and a quantized chroma latent sample by applying the quantization approach to the latent sample; generating the bitstream based on the quantized latent sample; and storing the bitstream in a non-transitory computer-readable recording medium.

### Example Device

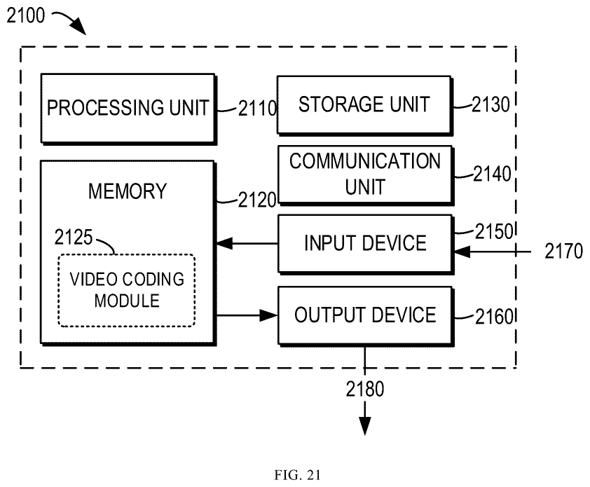

FIG. 21 illustrates a block diagram of a computing device 2100 in which various embodiments of the present disclosure can be implemented. The computing device 2100 may be implemented as or included in the source device 110 (or the video encoder 114 or 200) or the destination device 120 (or the video decoder 124 or 300).

It would be appreciated that the computing device 2100 shown in FIG. 21 is merely for purpose of illustration, without suggesting any limitation to the functions and scopes of the embodiments of the present disclosure in any manner.

As shown in FIG. 21, the computing device 2100 includes a general-purpose computing device 2100. The computing device 2100 may at least comprise one or more processors or processing units 2110, a memory 2120, a storage unit 2130, one or more communication units 2140, one or more input devices 2150, and one or more output devices 2160.

In some embodiments, the computing device 2100 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2100 can support any type of interface to a user (such as “wearable” circuitry and the like).

The processing unit 2110 may be a physical or virtual processor and can implement various processes based on programs stored in the memory 2120. In a multi-processor system, multiple processing units execute computer executable instructions in parallel so as to improve the parallel processing capability of the computing device 2100. The processing unit 2110 may also be referred to as a central processing unit (CPU), a microprocessor, a controller or a microcontroller.

The computing device 2100 typically includes various computer storage medium. Such medium can be any medium accessible by the computing device 2100, including, but not limited to, volatile and non-volatile medium, or detachable and non-detachable medium. The memory 2120 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2130 may be any detachable or non-detachable medium and may include a machine-readable medium such as a memory, flash memory drive, magnetic disk or another other media, which can be used for storing information and/or data and can be accessed in the computing device 2100.

The computing device 2100 may further include additional detachable/non-detachable, volatile/non-volatile memory medium. Although not shown in FIG. 21, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2140 communicates with a further computing device via the communication medium. In addition, the functions of the components in the computing device 2100 can be implemented by a single computing cluster or multiple computing machines that can communicate via communication connections. Therefore, the computing device 2100 can operate in a networked environment using a logical connection with one or more other servers, networked personal computers (PCs) or further general network nodes.

The input device 2150 may be one or more of a variety of input devices, such as a mouse, keyboard, tracking ball, voice-input device, and the like. The output device 2160 may be one or more of a variety of output devices, such as a display, loudspeaker, printer, and the like. By means of the communication unit 2140, the computing device 2100 can further communicate with one or more external devices (not shown) such as the storage devices and display device, with one or more devices enabling the user to interact with the computing device 2100, or any devices (such as a network card, a modem and the like) enabling the computing device 2100 to communicate with one or more other computing devices, if required. Such communication can be performed via input/output (I/O) interfaces (not shown).

In some embodiments, instead of being integrated in a single device, some or all components of the computing device 2100 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2100 may be used to implement video encoding/decoding in embodiments of the present disclosure. The memory 2120 may include one or more video coding modules 2125 having one or more program instructions. These modules are accessible and executable by the processing unit 2110 to perform the functionalities of the various embodiments described herein.

In the example embodiments of performing video encoding, the input device 2150 may receive video data as an input 2170 to be encoded. The video data may be processed, for example, by the video coding module 2125, to generate an encoded bitstream. The encoded bitstream may be provided via the output device 2160 as an output 2180.

In the example embodiments of performing video decoding, the input device 2150 may receive an encoded bitstream as the input 2170. The encoded bitstream may be processed, for example, by the video coding module 2125, to generate decoded video data. The decoded video data may be provided via the output device 2160 as the output 2180.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, a quantization approach of a latent sample based on whether the latent sample and a neighbor quantized latent sample is in a same region;
obtaining, using a neural network, a quantized latent sample comprising a quantized luma latent sample and a quantized chroma latent sample by applying the quantization approach to the latent sample; and
performing the conversion based on the quantized latent sample and one of: a synthesis transform network or an analysis transform network.

2. The method of claim 1, wherein obtaining the quantized latent sample comprising the quantized luma latent sample and the quantized chroma latent sample comprises at least one of:
in accordance with a determination that a neighbor quantized luma latent sample is in the same region as a luma latent sample, obtaining the quantized luma latent sample using the neighbor quantized luma latent sample;
in accordance with a determination that a neighbor quantized chroma latent sample is in the same region as a chroma latent sample, obtaining the quantized chroma latent sample using the neighbor quantized chroma latent sample;
in accordance with a determination that a neighbor quantized luma latent sample is not in the same region as a luma latent sample, obtaining the quantized luma latent sample without using the neighbor quantized luma latent sample;
in accordance with a determination that a neighbor quantized chroma latent sample is not in the same region as a chroma latent sample, obtaining the quantized chroma latent sample without using the neighbor quantized chroma latent sample; or
in accordance with a determination that a neighbor quantized latent sample is not in the same region as the latent sample, obtaining the quantized latent sample based on at least one padded sample.

3. The method of claim 1, wherein obtaining the quantized latent sample comprising the quantized luma latent sample and the quantized chroma latent sample comprises:
obtaining the quantized chroma latent sample using the quantized luma latent sample.

4. The method of claim 1, wherein a quantized latent representation is a tensor comprising a plurality of quantized latent samples, or
wherein the quantized latent representation is a matrix comprising the plurality of quantized latent samples.

5. The method of claim 1, further comprising at least one of:
obtaining a reconstructed image using the quantized luma latent sample and the quantized chroma latent sample with a synthesis transform network, wherein all indices associated with the neighbor quantized latent sample integers;
obtaining the latent sample using an analysis transform, wherein a luma component and chroma components of the latent sample employ a set of same analysis transform networks or separated analysis transform networks; or
determining whether the latent sample and the neighbor quantized latent sample is in a same region based on a tile map or a region map, and wherein the tile map is used to divide the quantized latent representation into a plurality of regions.

6. The method of claim 5, wherein the quantized luma latent sample and the quantized chroma latent sample employ separated synthesis transform networks, and/or
wherein the quantized latent representation is divided into 7 regions.

7. The method of claim 1, wherein the quantized luma latent sample and the quantized chroma latent sample employ an identical partitioning strategy, and/or
wherein the quantized luma latent sample and the quantized chroma latent sample employ separated indications for a splitting mode, and/or
wherein a luma latent sample employs a wavelet-based transformation style partitioning, and a chroma latent sample does not further split into sub-tiles, and/or
wherein a luma latent sample employs a wavelet-based transformation style partitioning, and a chroma latent sample employs the quad-tree partitioning where four identical sub-tiles are generated or a binary-tree partitioning where two identical sub-tiles are generated, and/or
wherein a luma latent sample employs a wavelet-based transformation style partitioning, and a chroma latent sample employs a recursive partitioning, wherein a splitting mode and a splitting depth are indicated to a decoder, and/or
wherein whether to employ the wavelet-based transformation style partitioning is indicated with one flag, and/or
wherein tile partitioning modes are determined according to a quantization parameter or target bitrate, and/or
wherein tile maps are applied to the quantized luma latent sample and the quantized chroma latent sample, corresponding outputs are adjusted with tile partitioning.

8. The method of claim 1, wherein the quantized latent representation is divided into N tiles, wherein N equals to 3,
luma and chroma latent sample employ 3 tiles partitioning such that the tiles within luma and chroma latent sample are independently processed.

9. The method of claim 8, wherein a sample belonging to one tile is processed using samples from the same tile, and/or
wherein the N tiles are processed in parallel.

10. The method of claim 1, wherein all tiles in luma and chroma latent samples are independent from each other.

11. The method of claim 1, wherein only tiles in luma components are independent of each other, and/or
wherein luma and chroma latent samples employ N-tiles partitioning, wherein N is an integer number.

12. The method of claim 1, wherein the tile map of luma and chroma samples is predetermined.

13. The method of claim 1, wherein the tile map is determined based on at least one indication in the bitstream.

14. The method of claim 13, wherein the at least one indication indicates one or more of:
the numbers of tiles in the tile map that divides the latent sample,
a size of the tiles in luma latent sample and chroma latent sample, or
position of tiles.

15. The method of claim 1, wherein luma and chroma components employ different synthesis transforms or the analysis transforms.

16. The method of claim 1, wherein the tile map is obtained according to a size of the quantized latent representation which is a matrix or tensor that comprises quantized latent samples, and/or
wherein the region map is obtained based on a size of the reconstructed image, and/or
wherein a tile map is obtained according to depth values that indicates depths of luma and chroma synthesis transforms, and/or
wherein the region map is obtained according to depth values of luma transform network and chroma transform network, and/or
wherein a probability modeling in entropy coding part utilizes coded group information, and/or
wherein the synthesis transform or the analysis transform are wavelet-based transforms, and/or
wherein performing the conversion based on the quantized latent sample and the synthesis transform network or the analysis transform network is applied to a first set luma and chroma latent samples, and/or
wherein performing the conversion based on the quantized latent sample and the synthesis transform network or the analysis transform network is not applied to a second luma and chroma latent samples, and/or
wherein performing the conversion based on the quantized latent sample and the synthesis transform network or the analysis transform network is applied to luma and chroma samples in a first region, and/or
wherein performing the conversion based on the quantized latent sample and the synthesis transform network or the analysis transform network is not applied to luma and chroma latent samples in a second region, and/or
wherein at least one of: region locations or dimensions is determined depending on color format or color components, and/or
wherein at least one of: region locations or dimensions is determined depending on whether a picture is resized, and/or
wherein whether and/or how to perform the conversion based on the quantized latent sample and the synthesis transform network or the analysis transform network depends on the latent sample location, and/or
wherein whether and/or how to perform the conversion based on the quantized latent sample and the synthesis transform network or the analysis transform network depends on whether the picture is resized, and/or
wherein whether and/or how to perform the conversion based on the quantized latent sample and the synthesis transform network or the analysis transform network depends on color format or color components, and/or
wherein the neural network is an auto-regressive neural network.

17. The method of claim 1, wherein the conversion includes encoding the video unit into the bitstream, and/or
wherein the conversion includes decoding the video unit from the bitstream.

18. An apparatus for video processing comprising a processor and a non-transitory memory with instructions thereon, wherein the instructions upon execution by the processor, cause the processor to:
determine, for a conversion between a video unit of a video and a bitstream of the video, a quantization approach of a latent sample based on whether the latent sample and a neighbor quantized latent sample is in a same region;
obtain, using a neural network, a quantized latent sample comprising a quantized luma latent sample and a quantized chroma latent sample by applying the quantization approach to the latent sample; and
perform the conversion based on the quantized latent sample and one of: a synthesis transform network or an analysis transform network.

19. A non-transitory computer-readable storage medium storing instructions that cause a processor to:
determine, for a conversion between a video unit of a video and a bitstream of the video, a quantization approach of a latent sample based on whether the latent sample and a neighbor quantized latent sample is in a same region;
obtain, using a neural network, a quantized latent sample comprising a quantized luma latent sample and a quantized chroma latent sample by applying the quantization approach to the latent sample; and
perform the conversion based on the quantized latent sample and one of: a synthesis transform network or an analysis transform network.

20. A non-transitory computer-readable recording medium storing a bitstream of a video which is generated by a method performed by an apparatus for video processing, wherein the method comprises:
determining a quantization approach of a latent sample of a video unit based on whether the latent sample and a neighbor quantized latent sample is in a same region;
obtaining, using a neural network, a quantized latent sample comprising a quantized luma latent sample and a quantized chroma latent sample by applying the quantization approach to the latent sample; and
generating the bitstream based on the quantized latent sample.
